(19) United States
(12) Patent Application Publication
(10) Pub. No.: US 2025/0050274 A1
(43) Pub. Date: Feb. 13, 2025

(54) APPARATUS AND PROCESS FOR MONOVALENT ION EXTRACTION

(71) Applicant: EVOVE LTD, Manchester (GB)

(72) Inventors: Kangsheng LIU, Manchester (GB); Tristan PHILLIPS, Manchester (GB); Fan FEI, Manchester (GB)

(21) Appl. No.: 18/719,098

(22) PCT Filed: Dec. 14, 2022
(86) PCT No.: PCT/GB2022/053234

§ 371 Date: Jun. 12, 2024

(30) Foreign Application Priority Data
Dec. 14, 2021 (GB) 2118074.0
Nov. 10, 2022 (GB) 2216798.5

(51) Int. Cl. B01D 61/02; B01D 69/12; B01D 71/56; B01D 71/60

(52) U.S. Cl. CPC B01D 61/0271; B01D 69/12; B01D 71/56; B01D 71/601; B01D 2311/06; B01D 2311/2623

(57) ABSTRACT

An apparatus for reducing the ratio of divalent ions to a monovalent ion in an aqueous solution from a source aqueous solution that contains a higher ratio of divalent ions to the target monovalent ion. The apparatus includes an optional prefiltration portion operable to receive the source aqueous solution and produce a prefiltered aqueous solution, a first separation portion, such as a nanofiltration separation portion, operable to receive the optionally prefiltered aqueous solution and form an intermediate aqueous solution having a lower ratio of divalent ions to the target monovalent ion than the prefiltered aqueous solution; and a second separation portion, such as an ion-exchange separation portion, operable to receive the intermediate aqueous solution and form a product aqueous solution having a lower ratio of the divalent ions to the target monovalent ion than the intermediate solution.

### FIELD

The present invention relates to extraction of a target monovalent ion from a source aqueous solution. More specifically, the present invention relates to an apparatus and process for reducing the ratio of divalent ions to a target monovalent ion in an aqueous solution from a source aqueous solution. The present invention also relates to an apparatus and process for increasing the ratio of a target monovalent ion to other ions in an aqueous solution from a source aqueous solution.

### BACKGROUND

Some monovalent ions, such as lithium, are used for various applications including ceramics and glass, lubricants and greases, catalysts, and more recently in batteries. The global consumption of monovalent ions such as lithium has more than doubled over the past 10 years, from 24.5 kt in 2010 to 56.0 kt in 2020. There are currently four primary resources for lithium: seawater, mineral deposits, brines, geothermal fluids. Extraction of lithium from seawater is currently economically infeasible because of low feed concentration (0.2 ppm). Compared to lithium extraction from ores, lithium extraction from brines is less time-consuming, and less energy and cost intensive. However, the traditional way of extraction lithium from brines is still far from efficient and environmentally friendly, involving natural evaporation and a series of precipitations with additions of huge amount of chemicals. There are hundreds of direct lithium extraction (DLE) technologies developed but with certain drawbacks such as tedious steps and low efficiency. The operating costs can be significantly reduced by decreasing the number of stages. When a relatively pure (>99.5%) but dilute (usually less than the lithium concentration in the brines) LiCl or LiOH solutions are obtained through direction lithium extraction (DLE), the final stage is usually concentration of lithium to a certain level (>5000 ppm) where Li₂CO₃ can be precipitated as final product. Such a final product may be termed a “dry product” being substantially free of a carrier liquid.

Current DLE methods typically employ ion exchange resins as the key stage to separate divalent ions from monovalent ions; however the majority of the water feed, such as Argentina Salars, geothermal brines, have high concentration of divalent and monovalent ions, the ion exchange resins are not capable of separating divalent ions from mono-valent ions (or vice versa) at high purity and are associated with high frequency of regeneration, shortened life span of ion resins, and longer down time.

It is therefore an object of aspects of the present invention to address one or more of the above mentioned or other problems.

### SUMMARY

According to a first aspect of the present invention, there is provided an apparatus for reducing the ratio of divalent ions, such as divalent cations, to a target monovalent ion, such as a target monovalent cation, in an aqueous solution from a source aqueous solution that contains a higher ratio of divalent ions to the target monovalent ion, the apparatus comprising
optionally, a prefiltration portion operable to receive the source aqueous solution and produce a prefiltered source aqueous solution;
a first separation portion operable to receive the optionally prefiltered aqueous solution and form an intermediate aqueous solution having a lower ratio of divalent ions to the monovalent ion than the optionally prefiltered aqueous solution; and
a second separation portion operable to receive the intermediate aqueous solution and form a product aqueous solution having a lower ratio of the divalent ions to the monovalent ion than the intermediate solution.

According to a second aspect of the present invention, there is provided a process for reducing the ratio of divalent ions to a monovalent ion in an aqueous solution, comprising:
a. optionally, contacting a source aqueous solution comprising the divalent ions and the monovalent ion with a prefiltration portion operable to produce a prefiltered aqueous solution;
b. contacting the optionally prefiltered aqueous solution with a first separation portion to form an intermediate aqueous solution having a lower ratio of the divalent ions to the monovalent ion than the optionally prefiltered aqueous solution;
c. contacting the intermediate solution with a second separation portion to form a product aqueous solution having a lower ratio of the divalent ions to the monovalent ion than in the intermediate solution.

According to a third aspect of the present invention, there is provided an apparatus for reducing the ratio of divalent ions, such as divalent cations, to a target monovalent ion, such as a target monovalent cation, in an aqueous solution from a source aqueous solution that contains a higher ratio of divalent ions to the target monovalent ion, the apparatus comprising;
optionally, a prefiltration portion operable to receive the source aqueous solution and produce a prefiltered source aqueous solution;
a nanofiltration separation portion operable to receive the optionally prefiltered source aqueous solution and form an intermediate aqueous solution having a lower ratio of divalent ions to the target monovalent ion than the optionally prefiltered source aqueous solution; and
an ion exchange separation portion operable to receive the intermediate aqueous solution and form a product aqueous solution having a lower ratio of the divalent ions to the target monovalent ion than the intermediate solution.

According to a fourth aspect of the present invention, there is provided a process for reducing the ratio of divalent ions, such as divalent cations, to a target monovalent ion, such as a target monovalent cation, in an aqueous solution, comprising:
a. optionally, contacting a source aqueous solution comprising the divalent ions and the target monovalent ion with a prefiltration portion operable to produce a prefiltered aqueous solution;
b. contacting the optionally prefiltered source aqueous solution with a nanofiltration separation portion to form an intermediate aqueous solution having a lower ratio of the divalent ions to the target monovalent ion than the optionally prefiltered source aqueous solution;
c. contacting the intermediate solution with an ion exchange separation portion to form a product aqueous solution having a lower ratio of the divalent ions to the target monovalent ion than in the intermediate solution.

According to a fifth aspect of the present invention, there is provided a product aqueous solution obtained by the process of the second or fourth aspect of the present invention. The product aqueous solution may be a refined and/or concentrated product aqueous solution.

### DETAILED DESCRIPTION

The apparatus and/or process of the first to fourth aspects of the present invention may be for use in (critical) metal extraction, such as for lithium, tungsten, tin, gold and/or silver extraction.

The apparatus and/or process of the first to fourth aspects of the present invention may be for use in lithium extraction, such as for direct lithium extraction (DLE). The aqueous solution obtainable by the apparatus and/or obtained by the process of the present invention may be operable to produce an aqueous solution comprising the target monovalent ion, such as lithium, in an amount of ≥100 ppm substantially in the absence of divalent ions, and in a purity of ≥99% when dried. As used herein, “substantially in the absence of divalent ions” may mean that divalent ions are present in an amount of <10 ppm, such as <5 ppm or <1 ppm. ‘The target monovalent ion’ may be one or more monovalent ion(s) that are to be isolated from other ions and contaminants.

Advantageously, the apparatus and process of the present invention provides improved metal extraction performance. In particular, an early-stage reduction of the ratio of divalent ions to target monovalent ions increases the capacity of downstream separation portions, such as ion-exchange resins, to extract divalent ions from the aqueous solution. This leads to improved efficiency and reduced cost of the process.

The apparatus and/or process of the present invention may comprise a prefiltration portion that is operable to receive the source aqueous solution, wherein the prefiltration portion is operable to form a prefiltered aqueous solution that may comprise reduced amounts of total suspended solids, such as silica, bacteria, and/or oil, compared to the source aqueous solution.

The prefiltration portion may comprise a separation portion comprising a membrane, such as a microfiltration and/or ultrafiltration membrane; a strainer and/or a filter.

The separation portion of the prefiltration portion may comprise a mean average pore size in the range of up to 100 μm, such as up to 75 μm, or up to 50 μm, such as up to 10 μm, such as up to 5 μm or up to 2 μm. The separation portion of the prefiltration portion may comprise a mean average pore size of at least from 200 nm, such as at least from 500 nm or at least from 1 μm, such as at least from 5 μm.

The separation portion of the prefiltration portion may comprise a polymer membrane, such as comprising polysulfone, polyethersulfone, polyvinylidene fluoride, polyester, polypropylene, polytetrafluoroethylene and/or polyamide (e.g. nylon); a ceramic membrane, such as comprising aluminium oxide, titanium oxide, and/or zirconium dioxide; a metal membrane, such as comprising carbon steel, galvanised steel, stainless steel, aluminium, and/or copper; or a combination thereof, such as a composite membrane comprising a polymeric composite, a ceramic composite, and/or a metallic composite.

The prefiltration portion may comprise a first and a second separation portion, such as a first and a second membrane, wherein the first portion has a mean average pore size that is larger than the mean average pore size of the second portion. Wherein the flow path of the aqueous solution contacts the first portion before it contacts the second portion.

The ratio of the mean average pore size of the first separation to the second separation may be at least >1:1, such as at least 3:1 or at least 4:1. The first separation portion may have a mean average pore size of at least 20 μm, such as at least 30 μm, or at least 40 μm. The second separation portion may have a mean average pore size of at least 1 μm, such as at least 5 μm, or at least 7 μm.

The source aqueous solution may be contacted with the separation portion of the prefiltration separation portion at a temperature of ≥5° C., such as ≥25° C. The source aqueous solution may be contacted with the separation portion of the prefiltration separation portion at a temperature of ≤100° C., such as ≤90° C. or ≤70° C. The temperature may be measured according to ASTM E2877-12 (2019): Standard Guide for Digital Contact Thermometers.

The source aqueous solution may be contacted with the separation portion of the prefiltration portion at a transmembrane pressure of ≥0.1 bar, such as ≥0.5 bar. The source aqueous solution may be contacted with the separation portion of the prefiltration portion at a transmembrane pressure of ≤5 bar, such as ≤3 bar, such as ≤2 bar, such as ≤1.5 bar. The pressure may be measured by a differential pressure transducer according to ASTM F2070-00 (2017): Standard Specification for Transducers, Pressure and Differential, Pressure, Electrical and Fiber-Optic.

The source aqueous solution may be contacted with the separation portion of the prefiltration portion at a pH of 20, such as ≥3, such as ≥5, such as ≥6. The source aqueous solution may be contacted with the separation portion of the prefiltration portion at a pH of ≤14, such as ≤10, such as $8. The pH may be measured according to ASTM ASTM E70-19: Standard Test Method for pH of Aqueous Solutions With the Glass Electrode.

The separation portion of the prefiltration portion may have a total suspended solids rejection of ≥90%, such as ≥95% or ≥99%.

As used herein, “total suspended solids (TSS)” means the dry-weight of suspended particles, that are not dissolved. The TSS may be measured according to ASTM D5907: Standard Test Methods for Filterable Matter (Total Dissolved Solids) and Nonfilterable Matter (Total Suspended Solids) in Water. For example, the TSS may be measured as follows:

$$T S S ( mg / L ) = ( Wfss - Wf ) / Vs$$

Where: Wfss: weight of filter with suspended solids Wf: weight of the filter Vs: volume of sample
1. Sample is filtered through a 1.5 μm, washed and dried, glass fibre filter.
2. Filtrate is transferred into an evaporating dish and liquid is allowed to evaporate to dryness.
3. Dish and residue are heated to 180° C. for one hour.
4. Dish and residue are cooled to room temperature and weighed on balance.
5. Repeat cycle of 180° C. heating, cooling, and weighing until two consecutive ±0.0005 g results.

The separation portion of the prefiltration portion may have a rejection rate for the target monovalent ion of ≤5%, such as ≤2% or ≤1%.

The first separation portion may comprise a membrane, such as a nanofiltration membrane, electrodialysis membrane and/or a metal-organic framework (MOF) membrane. The first separation portion may comprise a nanofiltration membrane in a nanofiltration separation portion. The nanofiltration separation portion of the third and fourth aspects may comprise a nanofiltration membrane.

Membrane separation uses a porous material to separate a mixture of components, generally by the application of a driving force applied across the surface of the membrane, such as pressure, or without an applied driving force, such as by gravity.

Membrane separation may be favoured over other separation technologies due to, in principle, lower cost, less space required for installation, no significant thermal input, lower energy consumption, reduced chemical treatments, higher removal efficiency and/or a lower requirement for the regeneration of spent media.

The nanofiltration membrane of the first separation portion or of the third or fourth aspect, may comprise a mean average pore size in the range of ≤10 nm, such as ≤5 nm or ≤2 nm. The nanofiltration membrane may comprise a mean average pore size of ≥0.1 nm, such as ≥0.2 nm or ≥0.5 nm. Pore size of the membrane can be measured by using a model of solute transport and an appropriate correlation between the hydrodynamic radius and molecular weight of the specific type of solute (e.g., polyethylene glycols). Background and examples can be found in: Hassan, A. R., and A. F. Ismail. “Characterization of nanofiltration membranes by the solute transport method: Some practical aspects in determining of mean pore size and pore size distributions” Regional Symposium on Membrane Science and Technology. 2004.

The nanofiltration membrane may comprise a molecular weight cut-off (MWCO) of ≤800 Da, such as ≤600 Da or ≤500 Da. The nanofiltration membrane may comprise a MWCO of ≥100 Da, such as ≥200 Da or ≥300 Da. The MWCO as used herein refers to the lowest molecular weight of a solute in Daltons in which 90% of that solute is retained by the membrane.

The nanofiltration membrane may comprise an organic and/or inorganic nanofiltration membrane, such as polymer and/or ceramic membrane.

The nanofiltration membrane may comprise a spiral wound membrane, tubular membrane, hollow fibre membrane and/or flat sheet membrane. The nanofiltration membrane may comprise a spiral wound membrane.

The nanofiltration membrane may comprise a polymer membrane, such as comprising polysulfone, polyethersulfone, and/or polyvinylidene fluoride; a ceramic membrane, such as comprising aluminium oxide, titanium oxide, and/or zirconium dioxide; a metal membrane, such as comprising carbon steel, galvanised steel, stainless steel, aluminium, and/or copper; or a combination thereof, such as a composite membrane comprising a polymeric composite, a ceramic composite, and/or a metallic composite.

The nanofiltration membrane may comprise a polymer membrane, such as comprising polyacrylonitrile (PAN); polyester such as polyethylene terephthalate (PET); polycarbonate (PC); polyamide (PA); poly(ether) sulfone (PES); polybutylene terephthalate (PBT); polysulfone (PSf); polypropylene (PP); cellulose acetate (CA); poly(piperazine-amide); polyvinylidene difluoride (PVDF); polytetrafluoroethylene (PTFE); chlorinated polyvinyl chloride (CPVC); poly(phthalazinone ether sulfone ketone) (PPESK); polyamide-urea; polyether ether ketone (PEEK); and/or poly(phthalazinone ether ketone; and/or a thin film composite porous film (TFC). The TFC may comprise an ultra-thin ‘barrier’ layer polymerised in situ over a porous polymeric support membrane, such as a commercially available polyamide derived TFC of an interfacially synthesized polyamide formed over a polysulfone (PSf) membrane. The TFC may comprise a poly(piperazine-amide)/poly(vinyl-alcohol) (PVA); poly(piperazine-amide)/poly(phthalazinone biphenyl ether sulfone (PPBES); and/or hydrolyzed cellulose tri-acetate (CTA)/cellulose acetate (CA). Preferably, the nanofiltration membrane comprises a polyethylene terephthalate-based (PET) membrane, such as poly(ether) sulfone (PES) and/or polyethylene terephthalate/polypropylene.

The nanofiltration membrane may comprise polyamide, such as a top layer comprising polyamide. The polyamide of the nanofiltration membrane may comprise the reaction product of a reaction mixture comprising acid chloride (such as trimesoyl chloride) and an amine (such as piperazine). The polyamide layer of the nanofiltration membrane may comprise the reaction product of a reaction mixture comprising a carboxylic acid (such as terephthalic acid) and an amine (such as poly(ethylene glycol) diamine) in the presence of a coupling reagent (such as 1-Ethyl-3-(3-dimethylaminopropyl) carbodiimide).

The nanofiltration membrane may comprise a multi-layered membrane comprising a support layer, an intermediate layer and a top layer. The support layer may comprise polyester, such as non-woven polyester, for example formed by electrospinning. The intermediate layer may comprise polysulfone and/or polyethersulfone, for example formed by phase inversion. The top layer may comprise polyamide, such as formed by interfacial polymerisation.

The optionally prefiltered source aqueous solution may be contacted with the nanofiltration membrane at a temperature of ≥5° C., such as ≥20° C. or ≥30° C. The optionally prefiltered source aqueous solution may be contacted with the nanofiltration membrane at a temperature of ≤100° C., such as ≤90° C. or ≤75° C. When the nanofiltration membrane comprises a polymer membrane the optionally prefiltered source aqueous solution may be contacted with the nanofiltration membrane at a temperature of ≤70° C.

The optionally prefiltered source aqueous solution may be contacted with the nanofiltration membrane at a transmembrane pressure of ≥5 bar, such as ≥10 bar, such as ≥15 bar. The optionally prefiltered source aqueous solution may be contacted with the nanofiltration membrane at a transmembrane pressure of ≤60 bar, such as ≤40 bar, such as ≤35 bar.

The optionally prefiltered source aqueous solution may be contacted with the nanofiltration membrane at a pH of ≥3, such as ≥5. The optionally prefiltered source aqueous solution may be contacted with the nanofiltration membrane at a pH of ≤11, such as ≤10 or ≤9.

The optionally prefiltered source aqueous solution may be contracted with the nanofiltration membrane at a crossflow velocity of ≥0.05 m/s, such as ≥0.1 m/s or ≥0.3 m/s. The optionally prefiltered source aqueous solution may be contracted with the nanofiltration membrane at a crossflow velocity of ≤3.5 m/s, such as ≤3 m/s or ≤1.5 m/s, such as ≤1 m/s or ≤0.8 m/s.

The nanofiltration separation portion may comprise a series of nanofiltration membranes, such as a series of fluidly connected sequential membranes. The nanofiltration separation portion may comprise a series of nanofiltration membranes wherein the retentate of a first nanofiltration membrane is operable to feed into at least one further nanofiltration membrane, such as at least two further nanofiltration membranes, suitably sequentially.

The nanofiltration separation portion may comprise at least two sets of nanofiltration membrane, each set comprising a series of nanofiltration membranes. In such an arrangement, the optionally prefiltered aqueous source solution may be formed into two or more branched flows operable to contact different sets of nanofiltration membranes in parallel. The discrete flows may be combined from the permeate outlet flows of the nanofiltration membrane sets.

The apparatus/process may comprise a batch apparatus/process for the nanofiltration separation portion. The apparatus/process may comprise means operable to recirculate the retentate stream of the nanofiltration membrane, such as via a feed tank wherein the retentate is optionally contacted with new optionally prefiltered aqueous source solution. The retentate steam may be recirculated for at least 5 hours per batch operation, such as at least 10 hours per batch operation. The retentate steam may be recirculated for up to 25 hours per batch operation, such as up to 20 hours per batch operation.

The nanofiltration membrane may have a divalent ion rejection of ≥60%, or ≥70%, such as ≥80% or ≥90%. The nanofiltration membrane may have a divalent ion rejection of ≤99%, such as ≤98% or ≤95%.

The nanofiltration membrane may have a rejection rate for the target monovalent ion of ≤50%, such as ≤20% or ≤5%.

The electrodialysis cell of the first separation portion may comprise a cation- and an anion-exchange membrane, suitably a series of each. The cation and anion-exchange membranes may be arranged in an alternating pattern between an anode and a cathode.

The cation- and/or anion-exchange membranes may be selective to monovalent ions over divalent ions.

Commercial examples of monovalent-selective ion-exchange membranes include: cation exchange membranes (e.g., Neosepta CMS, Selemion CSO); anion exchange membranes (e.g. Neosepta ACS and Selemion ASV).

The electrodialysis cell of the first separation portion may comprise a membrane having a mean average pore size in the range of $10 nm, such as ≤5 nm or ≤1 nm. The electrodialysis cell may comprise a membrane having mean average pore size of ≥0.1 nm such as ≥0.2 nm or ≥0.5 nm.

The electrodialysis cell of the first separation portion membrane may comprise a polymer membrane, such as a polymer membrane comprising a polystyrene and/or polyacrylic backbone, and/or comprising a sulfonic and/or carboxylic functional group.

The prefiltered aqueous solution may be contacted with the electrodialysis membrane at a temperature of ≥5° C., such as ≥10° C., such as ≥20° C. The prefiltered aqueous solution may be contacted with the electrodialysis membrane at a temperature of ≤60° C., such as ≤50° C., such as ≤40° C.

The prefiltered aqueous solution may be contacted with the electrodialysis membrane at substantially ambient pressure, such as a pressure of about 1 bar.

The prefiltered aqueous solution may be contacted with the electrodialysis membrane at a voltage of ≥0.1 V/cell-pair applied voltage, such as ≥0.5 V/cell-pair applied voltage. The prefiltered aqueous solution may be contacted with the electrodialysis membrane at a voltage of ≤5 V/cell-pair applied voltage, such as ≤2 V/cell-pair applied voltage.

The prefiltered aqueous solution may be contacted with the electrodialysis membrane at a pH of 20, such as ≥3, such as ≥6. The prefiltered aqueous solution may be contacted with the electrodialysis membrane at a pH of ≤14, such as ≤11, such as ≤8.

The electrodialysis membrane may have a divalent ion rejection of ≥80%, such as ≥90% or ≥95%.

The electrodialysis membrane may have rejection rate for the monovalent ion of ≤20%, such as ≤10% or ≤5%.

The first separation portion or the nanofiltration separation portion of any aspects may comprise means operable to provide cleaning in process (CIP) to the separation portion, such as to the nanofiltration membrane. The CIP means may be operable to flush the separation portion, such as the membrane, with an aqueous solution and/or clean the separation portion by passing a cleaning solution through the separation portion. The cleaning solution may comprise an acid cleaning solution and/or an alkaline cleaning solution. The sequence of acid cleaning and alkaline cleaning may be switched according to the type of fouling/scaling. The aqueous solution may have a pH of ≥6, such as ≥6.5 and/or $8, such as ≤7.5. The acid cleaning solution may have a pH of ≥1, such as ≥1.5 and/or ≤3, such as ≤2. The alkaline cleaning solution may have a pH of ≥8, such as ≥8.5 and/or ≤13, such as ≤12. The CIP means may be operable to flush the separation portion with an aqueous solution between acid cleaning and alkaline cleaning, and/or after the alkaline cleaning.

The aqueous solution and/or the cleaning solution of the CIP means may be contacted with the first separation portion, such as the nanofiltration membrane, at a temperature of ≥20° C., such as ≥25° C. or ≥30° C. The aqueous solution and/or the cleaning solution of the CIP means may be contacted with the first separation portion, such as the nanofiltration membrane, at a temperature of ≤50° C., such as ≤45° C. or ≤40° C.

The aqueous solution and/or the cleaning solution of the CIP means may be contacted with the first separation portion, such as the nanofiltration membrane, at a transmembrane pressure of ≥0.5 bar, such as ≥1 bar, such as ≥2 bar. The aqueous solution and/or the cleaning solution of the CIP means may be contacted with the first separation portion, such as the nanofiltration membrane at a transmembrane pressure of ≤15 bar, such as ≤10 bar, such as ≤5 bar.

The aqueous solution and/or the cleaning solution of the CIP means may be contacted with the first separation portion, such as the nanofiltration membrane, at a crossflow velocity of ≥0.05 m/s, such as ≥0.1 m/s or ≥0.3 m/s. The aqueous solution and/or the cleaning solution of the CIP means may be contacted with the first separation portion, such as the nanofiltration membrane, at a crossflow velocity of ≤3.5 m/s, such as ≤3 m/s or ≤1.5 m/s, such as ≤1 m/s or ≤0.8 m/.

The second separation portion may comprise an ion-exchange resin or membrane, such an ion-exchange resin, an electrodialysis ion-exchange membrane, an inorganic absorbent and/or a MOF membrane. The second separation portion may comprise an ion-exchange resin.

The ion exchange separation portion of the second separation portion, or of the third or fourth aspects may comprise an ion-exchange resin.

The ion-exchange resin of the ion exchange separation portion of any of the aspects may comprise a microporous (gel-type) and/or macroporous (porous type) resin.

The ion-exchange resin may comprise a macroporous (porous type) resin.

The ion-exchange resin may have a higher affinity for divalent ions, such as divalent cations, than for monovalent ions, such as monovalent cations. The ion-exchange resin may be substantially selective for divalent ions over monovalent ions.

The ion-exchange resin may comprise styrene, acrylic and/or divinylbenzene. The ion-exchange resin may be formed by polymerisation of a reaction mixture comprising monomers such as styrene and/or divinylbenzene. The ion-exchange resin may comprise a crosslinker, such as divinylbenzene.

The ion-exchange resin may be weakly acidic, such as by comprising carboxylic acid functionality.

The ion-exchange resin may comprise a chelating group, such as iminodiacetic acid, thiourea, amino phosphonic acid, amino methyl phosphonic acid, amidoxime, isothiouronium, phosphonic acid, sulfonic acid, bispicolylamine and/or di-2-ethylhexylphosphate (D2EHPA), and/or a residue thereof. The ion-exchange resin may comprise a chelating iminodiacetic acid group or residue thereof.

The ion-exchange resin may comprise a polymer comprising a polystyrene and/or polyacrylic backbone, and/or comprising a sulfonic and/or carboxylic functional group. Some examples of commercially available resins include: Lewatit TP 207, Lewatit TP 208, Lewatit TP 308, Amberlite IRC 748, Purolite S 930, Purolite S 9320, Puromet MTS9300, Puromet MTS9301, DIAION™ CR11, Chelex 100, SEPLITE LSC710 (weakly acidic, macroporous cation exchange resin with chelating iminodiacetic acid groups); Lewatit TP 214, Puromet MTS9140 (weakly acidic, macroporous cation exchange resin with chelating thiourea groups); Lewatit TP 260, AmberLite IRC747, Purolite S940, Puromet MTS9500, Puromet MTS9501, Puromet MTS9510, SEPLITE LSC750 (weakly acidic, macroporous cation exchange resin with chelating amino methyl phosphonic acid groups); Puromet MTS9100 (weakly acidic, macroporous cation exchange resin with chelating amidoxime groups); Puromet MTS9200 (weakly acidic, macroporous cation exchange resin with chelating isothiouronium groups); Puromet MTS9600 (weakly acidic, macroporous cation exchange resin with chelating bispicolylamine groups); and/or Lewatit VP OC 1026 (weakly acidic, macroporous cation exchange resin with chelating Di-2-ethylhexylphosphate (D2EHPA) groups).

The intermediate aqueous solution may be contacted with the ion-exchange resin at a temperature of ≥5° C., such as ≥20° C., or ≥30° C., or ≥40° C. The intermediate aqueous solution may be contacted with the ion-exchange resin at a temperature of ≤80° C., such as ≤70° C. or ≤60° C. The intermediate aqueous solution may be contacted with the ion-exchange resin at a temperature of $60° C., such as ≤50° C. It has surprisingly been found that in the process of the present invention the intermediate aqueous solution may be contacted with the ion-exchange resin at a lower temperature without suffering from a significant reduction in performance.

The intermediate aqueous solution may be contacted with the ion-exchange resin at a pressure of ≤2.5 bar, ≤1.5 bar, such as ≤1 bar.

The intermediate aqueous solution may be contacted with the ion-exchange resin at a pressure drop of ≥0.1 bar, such as ≥0.2 bar. The intermediate aqueous solution may be contacted with the ion-exchange resin at a pressure drop of ≤2 bar, such as ≤1 bar or ≤0.5 bar.

The intermediate aqueous solution may be contacted with the ion-exchange resin at a pH of ≥7, or ≥9. The intermediate aqueous solution may be contacted with the ion-exchange resin at a pH of ≤12, such as ≤11.

The intermediate aqueous solution may be contacted with the ion-exchange resin with a flow velocity or linear flowrate of ≥5 m/hr, or ≥10 m/hr. Advantageously, it has been found that using a flow velocity of ≥5 m/hr may reduce channelling effects and increase the effective utilisation of the resin. The intermediate aqueous solution may be contacted with the ion-exchange resin with a flow velocity or linear flowrate of ≤30 m/hr, or ≤25 m/hr, such as ≤20 m/hr, or ≤15 m/hr. Advantageously, it has been found that using a flow velocity of ≤30 m/hr improves ions exchange and reduces kinetic impairment.

The intermediate aqueous solution may be contacted with the ion-exchange resin at a volumetric flowrate of ≥5 BV/h, such as ≥10 BV/h, such as ≥20 BV/h. The intermediate aqueous solution may be contacted with the ion-exchange resin at a volumetric flowrate of ≤30 BV/h, such as ≤25 BV/h. As used herein, ‘BV’ refers to ‘Bed Volume’, which is the volume of the resin that is used in the ion exchange column.

The ion-exchange resin may have a divalent ion retention/adsorption of ≥90%, such as ≥95% or ≥99.9%.

In the presence of divalent ions, the ion-exchange resin may have a retention/adsorption rate for the target monovalent ion of ≤20%, such as ≤10% or ≤5%.

The selective inorganic absorbent of the second separation portion may comprise a water softening type of absorbent, operable to selectively absorb divalent and/or trivalent ions over monovalent ions.

The inorganic absorbent may comprise an inorganic crystalline solid, such as an aluminum hydroxide (AlOH), aluminum oxide (AlOx), manganese oxide (MnOx), and/or titanium oxide (TiOx).

The membrane of the first and/or second separation portion may comprise a MOF-containing membrane.

The MOF-containing membrane may comprise a mean average pore size in the range of ≤2 nm, such as $1 nm or ≤0.5 nm. The MOF membrane of the first separation portion may comprise a mean average pore size of ≥0.1 nm such as ≥0.2 nm or ≥0.3 nm.

The MOF membrane may comprise ZIF-7, ZIF-8, UiO-66, HKUST-1 and/or MOF-808.

The MOF membrane may comprise a polycrystalline MOF (PMOF) membrane, a mixed matrix membrane (MMMs), and/or a MOF-channel (MOFC) membrane.

The second separation portion, such as an ion-exchange separation portion of any aspect, may comprise means operable to clean the separation portion/ion-exchange resin. The cleaning means may be operable to displace residual brine from the separation portion/exchange resin, such as by downward flow (i.e. from inlet to outlet) with deionised water. The cleaning means may be operable to backwash the separation portion/resin, such as by upward flow (i.e. from outlet to inlet) with deionised water.

The ion-exchange separation portion of any aspect may comprise means operable to regenerate the ion-exchange resin. The regeneration means may be operable to chemically regenerate the resin by contacting the resin with an acid solution, such as by passing an acid solution through the resin, suitably downwardly through the resin, for example a hydrochloric acid solution, such as a 4 to 10% hydrochloric acid solution. The regeneration may substantially remove the mono and divalent metal ions adsorbed onto the resin. The regeneration may be followed by rinsing of the resin with deionised water.

The ion-exchange separation portion of any aspect may comprise means operable to condition the ion-exchange resin. The conditioning means may be operable to chemically regenerate the resin by contacting the resin with an alkaline solution, such as by passing a basic solution through the resin, suitably upwardly through the resin, for example a sodium hydroxide solution, such as a 1 to 10% sodium hydroxide solution. The conditioning may be operable to substantially deprotonate the weakly acidic functionality of the resin surface. The conditioning may be followed by rinsing of the resin with deionised water. The conditioning stage may follow the regeneration stage.

The ion-exchange separation portion may comprise at least two ion-exchange resin tanks, such as at least three. Each tank may comprise a dedicated feed inlet and effluent flow outlet. In the process of the present invention, at least two tanks may be actuating separation of the divalent ion from the target monovalent ion while at least one tank undergoes regeneration.

The ion-exchange separation portion may comprise at least two ion-exchange resin tanks arranged in series such that the intermediate aqueous solution is operable to contact a first ion-exchange resin tank before contacting a second ion-exchange resin tank. The first ion-exchange resin tank may have a higher level of saturation/be closer to requiring regeneration than the second ion-exchange resin tank. Advantageously, such a configuration of resin tanks may allow for continuous operation of the ion-exchange separation portion.

The source aqueous solution may be obtained from a brine source or from hard rock leaching solution that contains the target monovalent ion. The source aqueous solution may be seawater brine, saline lake brine, shallow groundwater brine, geothermal brine, deep brine in sedimentary basin and/or industrial brine. The source aqueous solution may be a geothermal brine, such as a geothermal brine obtained from a deep or a shallow geothermal source. The source aqueous solution may be leachate produced after processing, for example roasting, a mineral rock source, such as Spodumene mineral.

The source aqueous solution may be a produced water solution, such as a produced water solution obtained as a by-product during the extraction of oil and natural gas. The source aqueous solution may be leachate produced after processing of recycled batteries, for example leachate from recycled lithium-ion batteries.

The source aqueous solution may be an ocean seawater brine; a shallow brine beneath a dry lake, such as from Clayton Valley, Nevada, and/or Salar de Olaroz mine, Argentina; a geothermal brine, such as from Cornwall, United Kingdom and/or Salton Sea, California; and/or a deep brine, such as from Paradox Basin, Utah.

The source aqueous solution may be a deep or shallow geothermal brine, such as from Cornwall, United Kingdom and/or Salton Sea, California. The source aqueous solution may be a deep geothermal brine, such as from Cornwall, United Kingdom. A deep geothermal brine may be defined as brine extracted from a depth of >150 m. The source aqueous solution may be a shallow geothermal brine, such as from Cornwall, United Kingdom. A shallow geothermal brine may be defined as brine extracted from a depth of ≤150 m.

The divalent ions of any of the aspects may be divalent cations. The source solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y and/or Bi. Preferably, Ca, Mg and/or B.

The target monovalent ion may be a target monovalent cation, such as a metal monovalent cation.

The target monovalent cation of the source solution may comprise Na, K, Li, Cs, Rb, W, Au and/or Ag. Preferably, the target monovalent cation of the source solution comprises Li, W, Au, Ag, Na and/or K. More preferably, Li, W, Au and/or Ag. Most preferably, Li.

The different type of monovalent ion to the target monovalent ion may be a different type of monovalent cation, such as a different type of metal monovalent cation.

The source solution may comprise an anion, such as Cl, F, Br, SO₄, HCO₃, and/or CO₃. The source solution may comprise Cl and/or SO₄.

The source aqueous solution may comprise total suspended solids in an amount of ≥1 ppm, such as ≥5 ppm or ≥20 ppm.

The source aqueous solution may comprise total suspended solids in an amount of ≤2,000 ppm, such as ≤1,500 ppm or ≤1,000 ppm, or ≤500 ppm.

The source solution may comprise the divalent ions in an amount of ≤10,000 ppm, such as ≤5,000 ppm or ≤3,000 ppm.

The source solution may comprise the divalent ions in an amount of ≥100 ppm, such as ≥200 ppm or ≥500 ppm.

The source solution may comprise the target monovalent ion in an amount of ≤120,000 ppm, such as ≤50,000 ppm or ≤10,000 ppm.

The source solution may comprise the target monovalent ion in an amount of ≥20 ppm, such as ≥500 ppm or ≥1,000 ppm. It will be appreciated that the aqueous solutions may comprise other monovalent ions in addition to the target monovalent ion.

The source solution may comprise the target monovalent ion in an amount of ≤3,000 ppm, such as ≤1,000 ppm or ≤500 ppm.

The source solution may comprise the target monovalent ion in an amount of ≥10 ppm, such as ≥20 ppm or ≥50 ppm.

The source solution may comprise a ratio of the divalent ions to the target monovalent ion of ≥0.05:1, such as ≥0.5:1, or such as ≥2:1.

The source solution may comprise a ratio of the divalent ions to the target monovalent ion of ≤100:1, such as ≤50:1, or such as ≤20:1.

The prefiltered source aqueous solution may comprise substantially the same amounts of divalent and monovalent ions as the source aqueous solution, such as within 5% difference in ppm, or within 2% difference in ppm, or within 1% difference in ppm.

The prefiltered source aqueous solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B.

The target monovalent cation of the prefiltered source aqueous solution may comprise Na, K, Li, Cs, Rb, W, Au, and/or Ag. Preferably, the target monovalent cation of the prefiltered source solution comprises Li, W, Au, Ag, Na and/or K. More preferably, Li, W, Au and/or Ag. Most preferably, Li.

The prefiltered source aqueous solution may comprise anions, such as Cl, F, Br, SO₄, HCO₃, and/or CO₃. The prefiltered source aqueous solution may preferably comprise Cl and/or SO₄.

The prefiltered source aqueous solution may comprise a lower amount of total suspended solids, such as silica, bacteria, and/or oil/grease, than the source aqueous solution. The prefiltered source aqueous solution may comprise total suspended solids in an amount of ≤100 ppm, such as ≤50 ppm or ≤10 ppm.

The prefiltered source aqueous solution may comprise the divalent ions in an amount of ≤10,000 ppm, such as ≤5,000 ppm or ≤3,000 ppm.

The prefiltered source aqueous solution may comprise the divalent ions in an amount of ≥100 ppm, such as ≥200 ppm or ≥500 ppm.

The prefiltered source aqueous solution may comprise the target monovalent ion in an amount of ≤120,000 ppm, such as ≤50,000 ppm or ≤10,000 ppm.

The prefiltered source aqueous solution may comprise the target monovalent ion in an amount of ≥50 ppm, such as ≥500 ppm or ≥1,000 ppm. It will be appreciated that the prefiltered source aqueous solutions may comprise other monovalent ions in addition to the target monovalent ion.

The prefiltered source aqueous solution may comprise the target monovalent ion in an amount of ≤3,000 ppm, such as ≤1,000 ppm or ≤500 ppm.

The prefiltered source aqueous solution may comprise the target monovalent ion in an amount of ≥10 ppm, such as ≥20 ppm or ≥50 ppm.

The prefiltered source solution may comprise a ratio of the divalent ions to the target monovalent ion of ≥0.05:1, such as ≥0.5:1, or such as ≥2:1.

The prefiltered source solution may comprise a ratio of the divalent ions to the target monovalent ion of ≤100:1, such as ≤50:1, or such as ≤20:1.

The intermediate solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B.

The target monovalent cation of the intermediate source solution may comprise Na, K, Li, Cs, Rb, W, Au, and/or Ag. Preferably, the target monovalent cation of the intermediate solution comprises Li, W, Au, Ag, Na and/or K. More preferably, Li, W, Au and/or Ag. Most preferably, Li.

The intermediate source solution may comprise anions, such as Cl, F, Br, SO₄, HCO₃, and/or CO₃. The source solution may preferably comprise Cl and/or SO₄.

The intermediate solution may comprise the divalent ions in an amount of ≤4,000 ppm, such as ≤1,500 ppm or ≤1,000 ppm.

The intermediate solution may comprise the divalent ions in an amount of ≥5 ppm, such as ≥70 ppm or ≥150 ppm.

The intermediate solution may comprise the target monovalent ion in an amount of ≤120,000 ppm, such as ≤50,000 ppm or ≤10,000 ppm.

The intermediate solution may comprise the target monovalent ion in an amount of ≥20 ppm, such as ≥500 ppm or ≥1,000 ppm. It will be appreciated that the intermediate solution may comprise other monovalent ions in addition to the target monovalent ion.

The intermediate solution may comprise the target monovalent ion in an amount of ≤3,000 ppm, such as ≤1,000 ppm or ≤500 ppm.

The intermediate solution may comprise the target monovalent ion in an amount of ≥10 ppm, such as ≥20 ppm or ≥50 ppm.

The intermediate solution may comprise a ratio of the divalent ions to the target monovalent ion of ≥0.05:1, such as ≥0.5:1, or such as ≥2:1.

The intermediate solution may comprise a ratio of the divalent ions to the target monovalent ion of ≤100:1, such as ≤50:1, or such as ≤20:1.

The intermediate solution may comprise a ratio of a different type of monovalent ion to the target monovalent ion of ≥2:1, such as ≥10:1, or ≥20:1. This range may also apply to all other types of monovalent ion/cation that are not the target monovalent ion/cation.

The product solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B.

The target monovalent cation of the product solution may comprise Na, K, Li, Cs, Rb, W, Au and/or Ag. Preferably, the target monovalent cation of the product solution comprises Li, W, Au, Ag, Na and/or K. More preferably, Li, W, Au and/or Ag. Most preferably, Li.

The product solution may comprise anions, such as Cl, F, Br, SO₄, HCO₃, and/or CO₃. The product solution may preferably comprise Cl and/or SO₄.

The product solution may comprise the divalent ions in an amount of ≤10 ppm, such as ≤2 ppm or ≤1 ppm.

The product solution may comprise the target monovalent ion in an amount of ≤120,000 ppm, such as ≤50,000 ppm or ≤10,000 ppm.

The product solution may comprise the target monovalent ion in an amount of ≥20 ppm, such as ≥50 ppm or ≥1,000 ppm. It will be appreciated that the aqueous solutions may comprise other monovalent ions in addition to the target monovalent ion.

The product solution may comprise the target monovalent ion in an amount of ≤3,000 ppm, such as ≤1,000 ppm or ≤500 ppm.

The product solution may comprise the target monovalent ion in an amount of ≥10 ppm, such as ≥20 ppm or ≥50 ppm.

The product solution may comprise a ratio of the divalent ions to the target monovalent ion of ≤0.025:1, such as ≤0.0125:1, or such as ≤0.005:1.

The product solution may comprise a ratio of the divalent ions to the target monovalent ion of ≤0.1:1, such as ≤0.005:1, or such as ≤0.001:1.

The product solution may comprise a ratio of a different type of monovalent ion to the target monovalent ion of ≥2:1, such as ≥10:1, or ≥20:1. This range may also apply to all other types of monovalent ion/cation that are not the target monovalent ion/cation.

The apparatus and/or process of the present invention may be operable to reduce the ratio of a different type of monovalent ion to a target monovalent ion in an aqueous solution, such as a product aqueous solution, that contains a higher ratio of the different type of monovalent ion to the target monovalent ion. The apparatus and/or process of the present invention may be operable to reduce the ratio of all other types of monovalent ion/cation to a target monovalent ion/cation in an aqueous solution, such as a product aqueous solution, that contains a higher ratio of the different types of monovalent ions to the target monovalent ion.

The apparatus and/or process of the first or second aspects of the present invention may comprise a further separation portion, suitably operable to receive the product aqueous solution after the second separation portion. The further separation portion may comprise an ion exchange separation portion, an extractant, electrodialysis membrane, reverse osmosis membrane, and/or inorganic adsorbents. The further separation portion may comprise a (further, if an ion exchange separation portion is already present) ion exchange separation portion.

The apparatus and/or process of the third or fourth aspects of the present invention may comprise a further ion exchange separation portion, suitably operable to receive the product aqueous solution after the ‘first’ ion exchange separation portion.

The (further) ion exchange separation portion may be operable to separate the target monovalent ion from other types of monovalent ion. The (further) ion exchange separation portion may comprise a separation member operable to select for a specific type of monovalent ion. For example, the (further) ion exchange separation portion may comprise a lithium-specific separation member, such as an ion exchange resin, operable to extract Li+ from other monovalent cations that are different to the target monovalent ion, such as Na+ and K+.

The (further) ion exchange separation portion may be operable to receive the product aqueous solution and form a further refined product aqueous solution having a lower ratio of a different type of monovalent ion to the target monovalent ion. The refined product aqueous solution may be formed by recovery of the eluent in the (further) ion exchange separation portion. As such, the target monovalent ion may be retained in the eluent and other monovalent ions removed with the effluent.

In the method of the second or fourth aspect of the present invention, the method may further comprise:
d. contacting the product solution with a (further, at least with respect to the fourth aspect) ion exchange separation portion to form a refined product aqueous solution having a lower ratio of a different type of monovalent ion to the target monovalent ion.

The (further) ion-exchange resin of the ion exchange separation portion may comprise an ion-exchange resin. The (further) ion-exchange resin of the ion exchange separation portion may comprise a microporous (gel-type) and/or macroporous (porous type) resin.

The (further) ion-exchange resin may comprise a macroporous (porous type) resin.

The product aqueous solution may be contacted with the (further) ion-exchange resin at a temperature of ≥5° C., such as ≥20° C., or ≥30° C., or ≥40° C. The product aqueous solution may be contacted with the (further) ion-exchange resin at a temperature of ≤80° C., such as ≤70° C. or ≤60° C. The product aqueous solution may be contacted with the (further) ion-exchange resin at a temperature of ≤50° C.

The product aqueous solution may be contacted with the (further) ion-exchange resin at a pressure of ≤2.5 bar, ≤1.5 bar, such as ≤1 bar.

The product aqueous solution may be contacted with the (further) ion-exchange resin at a pressure drop of ≥0.1 bar, such as ≥0.2 bar. The product aqueous solution may be contacted with the (further) ion-exchange resin at a pressure drop of ≤2 bar, such as ≤1 bar or ≤0.5 bar.

The product aqueous solution may be contacted with the (further) ion-exchange resin at a pH of ≥7, or 29. The product aqueous solution may be contacted with the (further) ion-exchange resin at a pH of ≤12, such as ≤11.

The product aqueous solution may be contacted with the (further) ion-exchange resin with a flow velocity or linear flowrate of ≥5 m/hr, or ≥10 m/hr. The product aqueous solution may be contacted with the (further) ion-exchange resin with a flow velocity or linear flowrate of ≤20 m/hr, or ≤15 m/hr.

The product aqueous solution may be contacted with the (further) ion-exchange resin at a volumetric flowrate of ≥5 BV/h, such as ≥10 BV/h. The product aqueous solution may be contacted with the (further) ion-exchange resin at a volumetric flowrate of ≤20 BV/h, such as ≤15 BV/h.

The (further) ion-exchange resin may have a level of retention/adsorption for the target monovalent ion of ≥80%, such as ≥95% or ≥99.9%.

The (further) ion-exchange resin may have a retention/adsorption rate for monovalent ions other than the target monovalent ion of ≤20%, such as ≤10% or ≤5%.

The (further) ion-exchange separation portion may comprise means operable to clean the (further) ion-exchange resin. The cleaning means may be operable to displace residual brine from the exchange resin, such as by downward flow (i.e. from inlet to outlet) with deionised water. The cleaning means may be operable to backwash the resin, such as by upward flow (i.e. from outlet to inlet) with deionised water. The water cleaning may be applied following the regeneration and/or conditioning stage.

In the (further) ion exchange separation portion the target monovalent ion may be present in the eluent. The (further) ion-exchange separation portion may comprise means operable to extract the target monovalent ion in an eluent stream. The means to extract the target monovalent ion may comprise saturating the resin with the target monovalent ion and then contacting the saturated resin with an acid solution. The means to extract the target monovalent ion may comprise passing an aqueous solution through the resin comprising the target monovalent ion, such as a chloride salt solution, followed by passing an acid solution through the resin, suitably downwardly through the resin, for example a hydrochloric acid solution, such as a 0.5 to 11% hydrochloric acid solution. Advantageously, the aqueous solution comprising the target monovalent ion used in the eluting process as a means of saturating the resin may be obtained or derived from an output stream of the apparatus/process of the present invention, reducing the cost of the overall process.

The (further) ion exchange separation portion may comprise means for selective elution of the target monovalent ion, such as comprising applying a first dilute acid solution to the resin to remove monovalent ions other than the target monovalent ion before applying a more concentrated acid solution to elute the target monovalent ion.

The (further) ion-exchange separation portion may comprise means operable to regenerate the ion-exchange resin. The means operable to extract the target monovalent ion in an eluent stream may regenerate the ion-exchange resin. The extraction/regeneration may be followed by rinsing of the resin with deionised water.

The (further) ion-exchange separation portion may comprise means operable to condition the ion-exchange resin. The conditioning means may be operable to chemically regenerate the resin by contacting the resin with an alkaline solution, such as by passing a basic solution through the resin, suitably upwardly through the resin, for example a sodium hydroxide solution, such as a 0.5 to 10% sodium hydroxide solution. The conditioning may be followed by rinsing of the resin with deionised water. The conditioning stage may follow the regeneration stage.

The (further) ion-exchange separation portion may comprise at least two ion-exchange resin tanks, such as at least three. Each tank may comprise a dedicated feed inlet and permeate flow outlet. In the process of the present invention, at least two tanks may be actuating separation of the target monovalent ion from other types of monovalent ion while at least one tank undergoes regeneration.

The (further) ion-exchange separation portion may comprise at least two ion-exchange resin tanks arranged in series such that the product aqueous solution is operable to contact a first ion-exchange resin tank before contacting a second ion-exchange resin tank. The first ion-exchange resin tank may have a higher level of saturation/be closer to requiring regeneration than the second ion-exchange resin tank.

The refined product solution may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B.

The target monovalent cation of the refined product solution may comprise Na, K, Li, Cs, Rb, W, Au and/or Ag. Preferably, the target monovalent cation of the product solution comprises Li, W, Au, Ag, Na and/or K. More preferably, Li, W, Au and/or Ag. Most preferably, Li.

The refined product solution may comprise anions, such as Cl, F, Br, SO₄, HCO₃, and/or CO₃. The product solution may preferably comprise Cl and/or SO₄.

The refined product solution may comprise the divalent ions in an amount of ≤10 ppm, such as ≤7 ppm or ≤5 ppm.

The refined product solution may comprise the divalent ions in an amount of ≤3 ppm, such as ≤2 ppm or ≤1 ppm.

The refined product solution may comprise the target monovalent ion in an amount of ≤40,000 ppm, such as ≤10,000 ppm or ≤5,000 ppm.

The refined product solution may comprise the target monovalent ion in an amount of ≥100 ppm, such as ≥500 ppm or ≥1,000 ppm. It will be appreciated that the refined product solution may comprise other monovalent ions in addition to the target monovalent ion. The majority of the monovalent ions may be the target monovalent ion.

The refined product solution may comprise a ratio of the divalent ions to the target monovalent ion of ≤0.02:1, such as ≤0.01:1, or such as ≤0.005:1.

The refined product solution may comprise a ratio of a different type of monovalent ion to the target monovalent ion of ≤10:1, such as ≤5:1, or such as ≤1:1. This range may also apply to all other types of monovalent ion/cation that are not the target monovalent ion/cation.

The refined product solution may comprise a ratio of a different type of monovalent ion to the target monovalent ion of ≤0.1:1, such as ≤0.05:1, or such as ≤0.01:1. This range may also apply to all other types of monovalent ion/cation that are not the target monovalent ion/cation.

The apparatus and/or process of any aspect of the present invention may comprise a concentration portion operable to receive the (refined) product aqueous solution and reduce the water content of the solution such as to produce a concentrated product aqueous solution. The concentration portion may comprise a reverse osmosis membrane. Advantageously, the use of a reverse osmosis membrane may provide an efficient means of concentrating high purity monovalent ions solutions, such as lithium, for example before lithium carbonate is produced by evaporation/precipitation/crystallisation.

In the method of the second or fourth aspect of the present invention, the method may further comprise:
contacting the (refined) product solution with a concentration portion operable to receive the (refined) product aqueous solution and reduce the water content of the solution such as to produce a concentrated product aqueous solution.

The concentration portion may be contacted with the refined product solution as step (e).

The concentration portion may comprise a series of concentration membranes, such as a series of fluidly connected sequential membranes. The concentration portion may comprise a series of membranes wherein the retentate of a first membrane is operable to feed into at least one further membrane, such as at least two further nanofiltration membranes, or at least 4 or at least 6 membranes, suitably sequentially.

The concentration portion may comprise at least two sets of concentration membranes, each set comprising a series of membranes. In such an arrangement, the (refined) product aqueous source solution may be formed into two or more branched flows operable to contact different sets of nanofiltration membranes in parallel. The discrete flows may be combined from the permeate outlet flows of the reverse osmosis membrane sets.

The concentration portion may be operable to purify water obtained from the effluent of the (first) ion-exchange separation portion and/or the waste streams of one or more regeneration processes. The purified water may be operable to be returned for use in the process. Advantageously, such a configuration may reduce the running costs of the process.

The concentrated product solution, such as from a reverse osmosis concentration concentrate, may comprise divalent cations, and optionally trivalent cations, such as Ca, Mg, B, Ba, Fe, Mn, Zn, Mo, Sr, Zr, V, Cr, Te, Ti, Ga, Hg, Be, In, Ta, Ce, Hf, Sm, La, Nb, Th, Al, TI, As, Ni, Cu, Sc, Sn, Sb, Co, Pb, U, Cd, Y, and/or Bi. Preferably, Ca, Mg and/or B.

The target monovalent cation of the concentrated product solution may comprise Na, K, Li, Cs, Rb, W, Au and/or Ag. Preferably, the target monovalent cation of the product solution comprises Li, W, Au, Ag, Na and/or K. More preferably, Li, W, Au and/or Ag. Most preferably, Li.

The concentrated product solution may comprise anions, such as Cl, F, Br, SO₄, HCO₃, and/or CO₃. The concentrated product solution may preferably comprise Cl and/or SO₄.

The concentrated product solution may comprise the divalent ions in an amount of ≤10 ppm, such as ≤5 ppm.

The concentrated product solution may comprise the divalent ions in an amount of ≤3 ppm, such as ≤2 ppm or ≤1 ppm.

The concentrated product solution may comprise the target monovalent ion in an amount of ≤15,000 ppm, such as ≤10,000 ppm or ≤5,000 ppm.

The concentrated product solution may comprise the target monovalent ion in an amount of ≥100 ppm, such as ≥500 ppm or ≥1,000 ppm. It will be appreciated that the concentrated product solution may comprise other monovalent ions in addition to the target monovalent ion. The majority of the monovalent ions may be the target monovalent ion.

The concentrated product solution may comprise a ratio of the divalent ions to the target monovalent ion of ≤0.02:1, such as ≤0.01:1, or such as ≤0.005:1.

The concentrated product solution may comprise a ratio of a different type of monovalent ion to the target monovalent ion of $10:1, such as ≤5:1, or such as ≤1:1. This range may also apply to all other types of monovalent ion/cation that are not the target monovalent ion/cation.

The concentrated product solution may comprise a ratio of a different type of monovalent ion to the target monovalent ion of ≤0.1:1, such as ≤0.05:1, or such as ≤0.01:1. This range may also apply to all other types of monovalent ion/cation that are not the target monovalent ion/cation.

The concentrated product solution may comprise a concentration of the target monovalent ion of ≥0.5%, such as ≥2%, or such as ≥5%.

The apparatus and/or process of the present invention may be operable to produce a product aqueous solution (product-, refined product- and/or concentrated-product solution) having the target monovalent ion, such as lithium, retention compared to the amount of the target monovalent ion, such as lithium, in the source aqueous solution of ≥65%, such as ≥70% or ≥75%.

The apparatus and/or process of the present invention may be operable to form a concentrated product solution comprising ≥0.5% solid content, such as ≥2% solid content, or ≥5% solid content.

The apparatus and/or process of the present invention may be operable to form a concentrated product solution comprising ≥10% of the target monovalent ion/compound thereof, such as lithium/lithium compound, by solid content, such as ≥20%, or comprising ≥50% by solids.

The apparatus and/or process of the present invention may be operable to form a concentrated product solution comprising ≥90% of the target monovalent ion/compound thereof, such as lithium/lithium compound, by solid content, such as ≥95%, or comprising ≥99% by solids.

The membrane/resin of the prefiltration portion, first separation portion, nanofiltration separation portion, second separation portion, ion-exchange portion, further separation portion, further ion exchange portion and/or concentration portion may comprise a coating. The membrane of the nanofiltration separation portion and/or concentration portion may comprise a coating.

The coating may be operable to provide a separation effect. As such, the coating may be operable to selectively promote passage of some of the material to be separated through the member.

The nanofiltration portion may comprise a coating on the nanofiltration membrane. The coated portion of the membrane may have a mean average pore size of $2 nm, such as ≤1.5 nm or ≤1 nm. The coated portion of the membrane may be a non-porous membrane.

The coating may comprise a hydrophilic agent.

The coating of any aspect of the present invention may comprise a hydrophilic agent and a superhydrophilic agent. The coating may comprise a first coating layer comprising a hydrophilic agent and a second coating layer comprising a superhydrophilic agent. The second coating layer may be arranged over at least a part of the first coating layer.

The coating layer comprising a superhydrophilic agent may be arranged on the upper face of the membrane such that it is operable to contact the separation mixture in use.

The coating may be at least partially crosslinked and comprise a superhydrophilic agent.

The coating comprising a hydrophilic agent, optionally a superhydrophilic agent, and/or being at least partially crosslinked and comprising a superhydrophilic agent, may be formed from a coating composition comprising the hydrophilic agent or precursor thereof, when present, and/or the superhydrophilic agent or precursor thereof.

The surface of the membrane substrate operable to receive a coating may be hydrophilic. The contact angle of water on the substrate surface may be ≤65°, such as ≤60° and preferably ≤55°.

The membrane substrate may be a pre-treated substrate. The substrate may be treated prior to the addition of the coating formulations. For example, a surface of the membrane substrate may have been subjected to hydrophilisation to form a hydrophilic surface. Said substrate treatment may comprise the addition, suitably the grafting, of functional groups and/or the addition of hydrophilic additives. The added functional groups may be selected from one or more of hydroxyl, ketone, aldehyde, carboxylic acid and amine groups. Preferably hydroxyl or carboxylic acid groups.

The grafting of functional groups may be achieved by plasma treatment, corona discharge, redox reaction, radiation, UV-ozone treatment, and/or chemical treatment. One example of plasma treatment is using an oxygen plasma on the substrate for thirty seconds.

An example of a treated substrate is grafted hydroxyl groups on a polyethersulfone substrate introduced by plasma treatment. The functionalised groups of the substrate may be operable to interact with a functional group of the adjacent coating layer, such as with physical and/or chemical bonding. For example, the said grafted hydroxyl groups may be operable to react with carboxylated hydrophilic cellulosic materials in a coating layer via esterification or react with a siloxane component in an intermediate layer.

Additionally, or alternatively, surface treatment may be achieved by incorporating hydrophilic materials into the membrane substrate materials. As such, the membrane substrate may comprise hydrophilic material.

The hydrophilic material that may be incorporated into the substrate may comprise cellulose acetate, quaternized polyethersulfone, polylactic acid, polyethylenimine, polyetherimide, polyvinylpyrrolidone and/or poly(vinyl alcohol).

The hydrophilic material may be pre-blended into membrane substrate material. The hydrophilic material may be incorporated using methods such as phase inversion, extrusion and/or interfacial polymerisation.

The membrane substrate may comprise ≥1% hydrophilic material by weight of the substrate, such as ≥5 wt %, or ≥7 wt %. The substrate may comprise ≤50% hydrophilic material by weight of the substrate, such as ≤35 wt %, or ≥25 wt %. The substrate may comprise from 1 to 50% hydrophilic material by weight of the substrate, such as from 5 to 35 wt %, or from 7 to 25 wt %.

Advantageously, surface treatment of polymeric substrates may provide improved adhesion and uniformity of the subsequent coating layers applied on the substrate. The presence of said hydrophilicity and/or functionality on the polymeric substrate may provide a coating having a more robust mechanical integrity, a more uniform structure and improved continuity. The said hydrophilicity and/or functionality may also provide improved life span and/or stability. Surface treatment can also improve properties such as enhanced permeability.

The hydrophilic agent may be a material having a surface energy that is lower than the surface energy of the substrate.

The hydrophilic agent, and/or coating layer comprising the hydrophilic agent, may have a contact angle of ≤65°, such as ≤60°, or ≤55°, such as ≤50°.

The hydrophilic agent, and/or coating layer comprising the hydrophilic agent, suitably has a higher contact angle than the superhydrophilic agent, or the coating layer comprising the superhydrophilic agent.

The hydrophilic agent or precursor thereof may comprise a (co)polymer or oligomer, such as a polyelectrolyte, polydopamine, and/or polyethylenimine, or precursor thereof.

The hydrophilic agent (co)polymer or oligomer may be formed from a reaction mixture comprising a phenol (such as dopamine, tannic acid, vanillyl alcohol, eugenol, morin, and quercetin, for example dopamine) and a polyamine (such as polyethylenimine or polyallylamine, for example polyethylenimine), and/or a derivative thereof. The reaction mixture may comprise a phenol and a polyamine, and/or a derivative thereof, in a ratio of 5:1 to 1:5, such as 3:1 to 1:3, or 2:1 to 1:2 by weight.

The phenol may be co-deposited with the polyamine, and/or derivative thereof, such that a coating composition comprising both a phenol and polyamine, and/or a derivative thereof is applied to the membrane. Additionally or alternatively, the phenol and the polyamine, and/or a derivative thereof, may be applied sequentially from separate coating compositions, such as to form the reaction mixture on the surface of the membrane.

The polyamine or derivative thereof, may have a Mw of at least 300 Da, such as at least 400 Da or at least 500 Da. The polyamine or derivative thereof, may have a Mw of up to 750,000 Da, such as up to 25,000 Da or up to 10,000 Da.

The reaction mixture/coating composition may comprise an oxidant, such as sodium periodate, potassium persulfate, sodium persulfate, ammonium persulfate, ferric chloride, hydrogen peroxide and/or copper sulphate.

The hydrophilic agent (co)polymer may be branched.

The hydrophilic agent (co)polymer may have a weight average molecular weight (Mw) of at least 5,000 Da, such as at least 10,000 Da or at least 15,000 Da. The hydrophilic agent (co)polymer may have a weight average molecular weight (Mw) of up to 50,000 Da, such as up to 40,000 Da or up to 30,000 Da. The hydrophilic agent (co)polymer may have a weight average molecular weight (Mw) of from 5,000 to 50,000 Da, such as from 10,000 to 40,000 Da or from 15,000 to 30,000 Da.

The hydrophilic agent (co)polymer may be formed from vinylpyrrolidone, vinyl alcohol, allylamine, ethylenimine, allylammonium chloride, vinylamine, lysine, chitosan, silane-based and/or its derivatives; acrylics, such as water soluble acrylics; acrylamide (e.g., copolymers containing 2-acrylamido-2-methylpropane sulfonic acid-AMPS); and/or hydroxyalkylmethacrylate, such as hydroxyethylmethacrylate (e.g. poly HEMA), and copolymers thereof, such as with acrylic acid, methacrylic acid, and/or 2-acrylamido-2-methylpropane sulfonic acid.

The hydrophilic agent may be a copolymer formed from acrylamide and acrylic acid monomers with polyallylammonium chloride.

The hydrophilic agent may comprise a two-dimensional material and/or a nanoparticle material.

The hydrophilic agent may comprise a graphene-based material, metal organic framework material, silicene, germanene, stanene, boron-nitride, suitably h-boron nitride, carbon nitride, metal-organic nanosheets, molybdenum disulfide, tungsten disulfide, polymer/graphene aerogel, and/or positively charged polymers.

The graphene-based material may comprise graphene oxide, reduced graphene oxide, hydrated graphene, amino-based graphene, alkylamine functionalised graphene oxide, ammonia functionalised graphene oxide, amine functionalised reduced graphene oxide, octadecylamine functionalised reduced graphene oxide, and/or polymer graphene aerogel, preferably graphene oxide.

The hydrophilic agent may have an average platelet size of from 1 nm to 100,000 nm, such as from 10 nm to 50,000 nm, or from 100 nm to 15,000 nm, preferably from 500 nm to 14,000 nm.

The hydrophilic agent may have a platelet size distribution D50 of from 1 nm to 15,000 nm, preferably from 100 nm to 14,000 nm. The graphene-based material may have a platelet size distribution D90 of from 5 nm to 15,000 nm, preferably from 100 nm to 14,000 nm.

The hydrophilic agent may have an oxygen atomic content of from 1% to 70%, such as from 5% to 60%, or from 10% to 50%, preferably from 15% to 55%.

Suitably, the hydrophilic agent, preferably graphene-based material such as graphene oxide, comprises hydroxyl, carboxylic and/or epoxide groups. The oxygen content of the hydrophilic agent, preferably with functional groups of hydroxyl and/or carboxylic groups, may be up to 60% oxygen atomic percentage, such as up to 50% or up to 45% oxygen atomic percentage. Suitably, the oxygen content is from 20 to 25% or from 25 to 45%. Advantageously, when the oxygen content is from 25 to 45% a surfactant may not be required to maintain stability of the coating composition. Preferably, the oxygen content is from 25 to 40% oxygen atomic percentage. Such a range can provide improved stability of the coating composition despite the absence of other stabilising components such as surfactants, and provide enhanced interaction with a primer layer. Oxygen content may be characterised by X-ray photoelectron spectroscopy (XPS), K-Alpha grade, from ThermoFisher Scientific.

The oxygen content of the hydrophilic agent may be up to 50% oxygen atomic percentage.

The oxygen content of the hydrophilic agent may be from 25 to 45%.

The size distribution of the hydrophilic agent may be such that at least 30 wt % of the material have a diameter of between 1 nm to 5,000 nm, such as between 1 to 750 nm, 100 to 500 nm, 100 to 400 nm, 500 to 1000 nm, 1000 to 3000 nm, 1000 to 5000 nm, 1500 to 2500 nm, or 500 to 1500 nm, preferably 100 to 3000 nm, more preferably at least 40 wt %, 50 wt %, 60 wt %, 70 wt % and most preferably at least 80 wt % or at least 90 wt % or 95 wt % or 98 wt % or 99 wt %. The size of the hydrophilic agent and size distribution may be measured using transmission electron microscopy (TEM, JEM-2100F, JEOL Ltd. Japan).

The hydrophilic agent may be in the form of a monolayer or multi-layered particle, preferably a monolayer. The particles of hydrophilic agent may be formed of single, two or few layers of hydrophilic agent, wherein few may be defined as between 3 and 20 layers. Suitably, the hydrophilic agent may comprise from 1 to 15 layers, such as from 2 to 10 layers or 5 to 15 layers. Suitably, at least 30 wt % of the hydrophilic agent comprise from 1 to 15 layers, such as from 1 to 10 layers or 5 to 15 layers, more preferably at least 40 wt %, 50 wt %, 60 wt %, 70 wt % and most preferably at least 80 wt % or at least 90 wt % or 95 wt % or 98 wt % or 99 wt %. The number of layers in the hydrophilic agent may be measured using atomic force microscopy (AFM or transmission electron microscopy (TEM)) (TT-AFM, AFM workshop Co., CA, USA).

Suitably, the d-spacing between adjacent lattice planes in the hydrophilic agent or mixture thereof is from 0.34 nm to 5000 nm, such as from 0.34 nm to 1000 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 10 nm, or from 0.4 to 8 nm, such as from 0.4 to 7 nm, from 0.45 to 6 nm, 0.50 to 5 nm, or 0.55 to 4 nm, or 0.6 to 3 nm, for example 0.6 to 2.5 nm, 0.6 to 1 nm, 0.6 to 2 nm, or 0.6 to 1.5 nm.

The water contact angle of the superhydrophilic agent, the coating layer, or coating composition, suitably the water contact angle of the second coating layer comprising the superhydrophilic agent, may be ≤25°, such as ≤20°, such as ≤15°, preferably ≤10°. When used herein, the water contact angle was measured according to ASTM D7334-08.

The water contact angle of the superhydrophilic agent, or the coating layer, suitably the water contact angle of the second coating layer comprising the superhydrophilic agent, may be ≤20°.

The superhydrophilic agent may comprise a (co)polymer or oligomer, such as a polymer electrolyte, or precursor thereof.

The superhydrophilic (co)polymer and/or hydrophilic (co)polymer may comprise a hydrogel, or be operable to form a hydrogel upon contact with water.

The superhydrophilic agent (co)polymer may be formed from monomers including a vinyl monomer, such as styrene sulfonate salt, vinyl ether (such as methyl vinyl ether), N-vinyl-2-pyrrolidone (NVP), vinyl acetate (VAc); a silane-based monomer and/or its derivatives; an acrylic monomer, such as a (hetero) aliphatic (alk) acrylate, acrylic acids and salts thereof, bisphenol acrylics, fluorinated acrylate, methacrylate, polyfunctional acrylate, hydroxyethoxyethyl methacrylate (HEEMA), hydroxydiethoxyethylmethacrylate (HDEEMA), methoxyethyl methacrylate (MEMA), methoxyethoxyethyl methacrylate (MEEMA), methoxydiethoxyethyl methacrylate (MDEEMA), ethylene glycol dimethacrylate (EGDMA), acrylic acid (AA), PEG acrylate (PEGA), PEG methacrylate (PEGMA), PEG diacrylate (PEGDA), PEG dimethacrylate (PEGDMA), bis(trimethylsilyloxy)methylsilylpropyl glycerol methacrylate (SiMA), methacryloyloxyethyl phosphorylcholine (MPC), 6-acetylthiohexyl methacrylate, acrylic anhydride, [2-(acryloyloxy)ethyl]trimethylammonium chloride, 2-(4-benzoyl-3-hydroxyphenoxy)ethyl acrylate, benzyl acrylate, or their trimethacrylate, dimethacrylate tri-block derivatives; thiol functionalised acrylate monomers, such as thiol functionalised (meth)acrylate; acryloyl chloride; acrylonitrile; maleimide; an acrylamide based monomer, such as acrylamide, methacrylamide; N,N-dimethylacrylamide (DMA), 2-acrylamido-2-methylpropane sulfonic acid, N-isopropyl AAm (NIPAAm), N-(2-hydroxypropyl) methacrylamide (HPMA), 4-acryloylmorpholine; carbohydrate monomer; a polyacid and/or polyol, such as maleic acid (such as maleic acid with a vinyl ether (e.g., Gantrez, partially neutralised with sodium)), ethylene glycol (EG); gelatin methacryloyl; and/or methacrylated hyaluronic acid, optionally with crosslinkers such as epichlorohydrin (ECH), N,N′-methylene-bis-acrylamide (BIS) and/or divinyl sulfone (DVS).

A superhydrophilic agent (co)polymer may have a molecular weight (Mw) of ≥2,000 g/mol, such as ≥4,000 g/mol, or ≥6,000 g/mol. For example, up to ≤30,000 g/mol, such as up to ≤20,000 g/mol, or up to ≤15,000 g/mol. For example, from 2,000 to 30,000 g/mol, such as from 4,000 to 20,000 g/mol, or from 6,000 to 15,000 g/mol.

The superhydrophilic agent (co)polymer may have a molecular weight (Mw) of ≥6,000 g/mol.

The superhydrophilic agent (co)polymer may have a molecular weight (Mw) of from 2,000 to 30,000 g/mol.

The coating or coating composition may comprise a film former, such as a linear and/or hydrophilic polymer (e.g. PVP etc). A film former may be selected from a polysaccharide or derivative thereof, such as cellulose or a derivative thereof, for example methylcellulose, hydroxyethyl cellulose, hydroxypropyl cellulose, hydroxypropyl methylcellulose, cellulose acetate phthalate, hydroxypropyl methylcellulose phthalate, carboxymethyl ethylcellulose, hydroxypropyl methylcellulose acetate succinate, ethylcellulose, sodium alginate; acrylic (co)polymers; vinyl (co)polymer, such as polyvinyl pyrrolidone; polyvinyl alcohol, polyvinyl acetate phthalate; polyethylene glycol, polyethyleneimine (PEI); and/or poly(ethylene) oxide. Preferably, the film former comprises a water-soluble film former, such as hydroxypropyl methylcellulose acetate succinate.

The amount of film former in the coating composition may be ≤10 wt % by dry weight of the coating composition, such as ≤5 wt %, such as ≤4 wt %, ≤3.5 wt %, ≤3 wt %, ≤2.5 wt %, preferably ≤2 wt %

The hydrophilic agent, superhydrophilic agent, or precursors thereof, coating layer and/or film former, when present, may be at least partially crosslinked, or be operable to be at least partially crosslinked. The hydrophilic agent, superhydrophilic agent, or precursors thereof, film former and/or coating layer may be at least partially crosslinked by using an additive crosslinker. As such, the coating composition comprising the hydrophilic agent, superhydrophilic agent and/or film former may further comprise an additive crosslinker. The hydrophilic agent, superhydrophilic agent, or precursors thereof, coating layer and/or film former, may be at least partially self-crosslinked, or be operable to be self-crosslinked prior to application. As used herein “self-crosslinked” means crosslinking between two or more polymer chains wherein the crosslinking moiety was a functional group present on the polymer backbone prior to crosslinking.

The hydrophilic, superhydrophilic (co)polymer, or precursors thereof, and/or film former (co)polymer, when present, may be formed from a crosslinker or residue thereof, suitably in an amount of ≥0.5% by weight of the total monomers of the (co)polymer, or ≥0.8 wt % or ≥1 wt %. For example, up to $15% by weight of the total monomers of the (co)polymer, up to ≤10 wt % or up to $5 wt %. For example, from 0.5 to 15% by weight of the total monomers of the (co)polymer, or from 0.8 to 10 wt % or from 1 to 5 wt %.

The coating composition may comprise a crosslinker in an amount of ≥0.5% by dry weight the composition, such as ≥0.8 wt % or ≥1 wt %. For example, up to ≤15% by dry weight the composition, such as up to ≤10 wt % or up to ≤5 wt %. For example, from 0.5 to 15% by by dry weight the composition, such as from 0.8 to 10 wt % or from 1 to 5 wt %.

The superhydrophilic (co)polymer may be formed from a crosslinker in an amount of ≥0.5% by weight of the total monomers of the (co)polymer.

The hydrophilic, superhydrophilic (co)polymer, or precursors thereof, and/or film former (co)polymer, when present, may be formed from a crosslinker or residue thereof, suitably in an amount of from 0.5 to 15% by weight of the total monomers of the (co)polymer.

The crosslinker may be a multi-functional acrylic or vinyl monomer, a divalent metal ion, multi-functional carbodiimide, multi-functional aziridine, silane; multi-functional epoxide and/or multi-functional isocyanate, or residue thereof.

The crosslinker may comprise tetramethylethylenediamine, methylene bis-acrylamide, ethylene glycol dimethacrylate, polyethylene glycol dimenthacrylate, triethylene glycol dimethacrylate N-isopropylacrylamide; N,N-diethylacylamide, epichlorohydrin (ECH), N,N′-methylene-bis-acrylamide (BIS), divinyl sulfone (DVS), citric acid, dicysteine peptides, dithiothreitol (DTT), glutaraldehyde; enzymatic crosslinking, such as transglutaminase, and a combination of horseradish peroxidase (HRP) and hydrogen peroxide, or a residue thereof.

The hydrophilic agent, superhydrophilic agent, or precursors thereof, and/or film former when present, may comprise a functional group that is operable to be crosslinked, or residue thereof. For example, the hydrophilic agent, superhydrophilic agent, or precursors thereof, and/or film former when present, may comprise acid functionality, such as carboxylic acid functionality, or residues thereof. In the coating, the crosslinking density may be at least 2 molar % of the crosslinkable functional groups, such as at least 5 molar % or at least 10 molar %.

The crosslinking density may be at least 2 molar % of the crosslinkable functional groups.

As used herein, the crosslinking density was measured by the following method. The polymer was swelled in a solvent until equilibrium. The swollen gel was then isolated and weighed. The weights of swelling solvent and polymer were determined after removing the solvent by vacuum-drying. The following equation was then applied:

Crosslink density, network chain per gram=[ln(1−Vp)+(Vp)+X(Vp)\hat{ }2]/{Dp(Vo)[(Vr)\hat{ }(⅓)−(Vp)/2]}
where
Vp=Volume fraction of polymer in the swollen polymer
X=Huggins polymer-solvent interaction constant
Dp=Density of polymer (g/cm\hat{ }3)
Vo=Molar volume of solvent (cm\hat{ }3/mol)
Do=Density of solvent (g/cm\hat{ }3)
Here,

Vp=1/(1+Q),
Where Q is the ratio of the weight of solvent in swollen polymer (XDp) and the weight of polymer (XDo).

The superhydrophilic agent may be a polyelectrolyte (co)polymer selected from a (meth)acrylic acid (co)polymer; and/or a styrene sulfonate acid (co)polymer, wherein at least part of the acid is in the form of a suitable salt.

The superhydrophilic agent may be a polyelectrolyte copolymer selected from poly(styrene-alt-maleic acid) sodium, chitosan-g-poly(acrylic acid) copolymer sodium; 2-propenoic acid, 2-methyl, polymer with sodium; and/or 2-methyl-2 ((1-oxo-2-propen-1-yl)amino)-1-propanesulfonate.

The superhydrophilic agent may comprise a (co)polymer hydrogel selected from: carboxymethyl cellulose (CMC), and/or polyvinylpyrrolidone (PVP) hydrogel, crosslinked for example by tetra(ethylene glycol) dimethacrylate, such as via free radical polymerisation, suitably wherein at least part of the acid is in the form of a suitable salt, such as a carboxymethyl cellulose (CMC) sodium; N-isopropylacrylamide (NIPAAm) with poly(ethylene glycol)-co-poly(ε-caprolactone) (PEG-co-PCL), crosslinked for example by N,N-methylene bisacrylamide and/or sodium alginate, for example by using template copolymerisation, or UV light or crosslinked by N,N,N′,N′-tetramethylethylenediamine (TEMED) and/or ammonium persulphate (APS) with UV light, such as alginate and alginate derivatives; 3-(methacryloyloxy)propyltris(trimethylsiloxy)silane, N,N-dimethylacrylamide, 3-(methacryloyloxy)propyltris(trimethylsiloxy)silane 1-vinyl-2-pyrrolidinone, and/or 2-hydroxyethylmethacrylate (TRIS-DMA-NVP-HEMA copolymer hydrogel).

Hydrogel when used herein in relation to the hydrophilic agent and the superhydrophilic agent may mean an insoluble polymeric network characterized by the presence of physical and/or chemical crosslinking among the polymer chains and the presence of water, suitably in a non-insignificant amount, such as in an amount of at least 10% of the total weight of the polymer composition. The hydrophilic agent and/or the superhydrophilic agent may be in the form of a dehydrated hydrogel that is operable to form a hydrated hydrogel upon contact with water.

The superhydrophilic agent may comprise a poly(styrene sulphonate salt) and/or a polyacrylic acid salt.

The term “precursor” when used herein in relation to the hydrophilic and superhydrophilic agents refers to a compound that is operable to form the hydrophilic or superhydrophilic agent using methods known to the skilled person. For example, the precursor may be an oligomer, or pre-crosslinked polymer which form the hydrophilic or superhydrophilic agent after chemical or physical crosslinking, such as with UV-light with photo-initialiser, heat treatment, etc. For example, a precursor may comprise a mixture of acrylamide and acrylic acid monomers with poly(allylamonium chloride), and with 2,2′-Azobis(2-methylpropionamidine) dihydrochloride (AIBA) as initiator, and N,N′-methylene bisacrylamide (MBAM) as crosslinker. This mixture may be considered to be a hydrophilic agent precursor as it is operable to form a hydrophilic agent in the coating via template polymerisation. Another example of a suitable precursor includes polyethylene glycol (PEG) mixed with triethylene glycol dimethacrylate (TEGDMA), which is operable to form the hydrophilic agent in the coating layer via UV light with a photo-initiator.

The coating composition/reaction mixture may comprise a buffer agent, operable to maintain the as composition/mixture at a suitable pH range, such tris(hydroxymethyl)aminomethane (Tris). The pH of the coating composition may be from 8 to 9, such as from 8 to 8.5.

The thickness of the coating, suitably of the first coating layer/layer comprising a hydrophilic agent, may be from 1 nm to 2000 nm, such as from 1 to 1000 nm, or from 5 to 500 nm, such as 5 to 200 nm.

The thickness of the coating layer comprising the superhydrophilic agent may be up to 100 μm.

The membrane may comprise an intermediate layer between the membrane substrate and a first coating layer, and/or between a first coating layer and a second coating layer.

The intermediate layer may comprise an adhesion promoter selected from silane or a derivative thereof, tannic acid, dopamine or a derivative thereof, and/or dopamine peptide; amine; diamine; methacrylate; epoxy; methyl, isobutyl, phenyl, octyl, or vinyl, chloroalkyl; vinylbenzylamino based adhesion promoter; organometallic such as organotitanate, organozirconate, organoaluminate; chlorinated or chlorine-free polyolefin; polyol based adhesion promoter; and/or polyester based adhesion promoter.

The adhesion promoter may comprise a silane based adhesion promoter such as an acrylate and/or methacrylate functional silane, aldehyde functional silane, amino functional silane; such as amino alkoxysilane, anhydride functional silane, azide functional silane, carboxylate phosphonate and/or sulfonate functional silane, epoxy functional silane, ester functional silane, halogen functional silane, hydroxyl functional silane, isocyanate and/or masked isocyanate functional silane, phosphine and/or phosphate functional silane, sulfur functional silane, vinyl and/or olefin functional silane, multi-functional and/or polymeric silane, UV active and/or fluorescent silane, and/or chiral silane, trihydrosilane.

The adhesion promoter may comprise 3-aminopropyl trimethoxy silane

The coated membrane may be formed by:
a. optionally, preparing a substrate by treating the substrate with physical rinsing, chemical treatment, radiation treatment, plasma treatment, and/or thermal treatment;
b. optionally, contacting the substrate with an intermediate layer coating composition to form an intermediate layer;
c. contacting the membrane substrate with a coating composition comprising a hydrophilic agent or precursor thereof, and optionally further comprising a superhydrophilic agent or precursor thereof, to form a coating layer;
d. optionally, contacting the coating layer with an intermediate layer coating composition to form an intermediate layer;
e. optionally contacting the coated substrate with a coating composition comprising a superhydrophilic agent or precursor thereof to form a further coating layer, for example if a superhydrophilic agent was not contacted with the substrate in step (c).

The coated membrane may be formed by:
a. optionally, preparing a substrate by treating the substrate with physical rinsing, chemical treatment, radiation treatment, plasma treatment, and/or thermal treatment;
b. optionally, contacting the membrane substrate with an intermediate layer coating composition to form an intermediate layer;
c. optionally, contacting the membrane substrate with a coating composition comprising a hydrophilic agent or precursor thereof to form a coating layer;
d. optionally, contacting the coating layer with an intermediate layer coating composition to form an intermediate layer;
e. contacting the optionally coated substrate with a coating composition comprising a superhydrophilic agent or precursor thereof to form a coating layer;
   wherein the coating layer comprising the superhydrophilic agent is at least partially crosslinked.

The coating may comprise a lamellar structure comprising at least two layers of two-dimensional material, and wherein the two-dimensional material comprises graphene or a derivative thereof. The coating may be formed from a coating composition comprising graphene or a derivative thereof.

The graphene or derivative thereof may be selected from one or more of graphene oxide, reduced graphene oxide, hydrated graphene and amino-based graphene, alkylamine functionalised graphene oxide, ammonia functionalised graphene oxide, amine functionalised reduced graphene oxide, octadecylamine functionalised reduced graphene oxide, and/or polymer graphene aerogel. Preferably, the graphene or derivative thereof is graphene oxide. Graphene and its derivatives may be obtained commercially from Sigma-Aldrich.

Suitably, the graphene or derivative thereof, preferably graphene oxide, comprises hydroxyl, carboxylic and/or epoxide groups. The oxygen content of the graphene or derivative thereof, preferably graphene oxide, may be 0% to 60% oxygen atomic percentage, such as 0% to 50% or 0% to 45% oxygen atomic percentage. Suitably, the oxygen content is from 20% to 25% or from 25% to 45%. Advantageously, when the water content is between 25% to 45% a surfactant may not be present in the composition. Preferably, the oxygen content is from 30% to 40% oxygen atomic percentage. Such a range can provide improved stability despite the absence of other stabilising components. Suitably, when the graphene or derivative is reduced graphene oxide, the oxygen content is from 5% to 20% oxygen atomic percentage. Oxygen content can be characterised by X-ray photoelectron spectroscopy (XPS).

The graphene or derivative thereof, suitably graphene oxide, may be optionally substituted with further functional groups. The optional functional groups may be grafted functional groups, and preferably grafted via reaction with the existing hydroxyl, carboxylic and epoxide groups of the graphene or derivative thereof. Functionalisation includes covalent modification and non-covalent modification. Covalent modification method can be subcategorised to nucleophilic substitution reaction, electrophilic substitution reaction, condensation reaction, and addition reaction. Examples of optional functional groups are amine groups; aliphatic amine groups, such as long-chain (e.g. C₁₈ to C₅₀) aliphatic amine groups; porphyrin-functionalised secondary amine groups, and/or 3-amino-propyltriethoxysilane groups. The graphene or derivative thereof may comprise amino groups, suitably grafted amino groups, and preferably to graphene oxide. Such functionalisation can provide for the improved selective sieving of ferric acid.

The graphene or derivative thereof according to any aspect of the present invention may be in the form of flakes having a size of from 1 nm to 5000 nm, such as between 50 nm to 750 nm, 100 nm to 500 nm, 100 nm to 400 nm. The graphene or derivative thereof according to any aspect of the present invention may be in the form of flakes having a size of from 100 nm to 3500 nm, such as from 200 nm to 3000 nm, 300 nm to 2500 nm or 400 nm to 2000 nm, preferably from 500 nm to 1500 nm. The graphene or derivative thereof according to any aspect of the present invention may be in the form of flakes having a size of from 500 nm to 4000 nm, 500 nm to 3500 nm, 500 nm to 3000 nm, 750 nm to 3000 nm, 1000 nm to 3000 nm, such as 1250 nm to 2750 nm or preferably 1500 nm to 2500 nm. Suitably, the size distribution of the graphene flakes or derivative thereof is such that at least 30 wt % of the graphene flakes or derivative thereof have a diameter of between 1 nm to 5000 nm, such as between 1 nm to 750 nm, 100 nm to 500 nm, 100 nm to 400 nm; or between 100 nm to 3500 nm, such as from 200 nm to 3000 nm, 300 nm to 2500 nm or 400 nm to 2000 nm, preferably from 500 nm to 1500 nm; or between 500 nm to 4000 nm, 500 nm to 3500 nm, 500 nm to 3000 nm, 750 nm to 3000 nm, 1000 nm to 3000 nm, such as 1250 nm to 2750 nm or preferably 1500 nm to 2500 nm, more preferably at least 40 wt %, 50 wt %, 60 wt %, 70 wt % and most preferably at least 80 wt % or at least 90 wt % or 95 wt % or 98 wt % or 99 wt %. The size of the graphene flakes or derivative thereof and size distribution may be measured using transmission electron microscopy (TEM, JEM-2100F, JEOL Ltd. Japan).

The graphene or derivative thereof may be in the form of a monolayer or multi-layered particle, preferably a monolayer. The graphene flakes or derivative thereof may be formed of single, two or few layers of graphene or derivative thereof, wherein few may be defined as between 3 and 20 layers. Suitably, the graphene flakes or derivative thereof comprise between 1 to 15 layers, such as between 2 to 10 layers or 5 to 15 layers. Suitably, at least 30 wt % of the graphene flakes or derivative thereof comprise between 1 to 15 layers, such as between 1 to 10 layers or 5 to 15 layers, more preferably at least 40 wt %, 50 wt %, 60 wt %, 70 wt % and most preferably at least 80 wt % or at least 90 wt % or 95 wt % or 98 wt % or 99 wt %. The number of layers in the graphene flakes or derivative thereof may be measured using atomic force microscopy (AFM or transmission electron microscopy (TEM)) (TT-AFM, AFM workshop Co., CA, USA).

Suitably, the d-spacing between adjacent lattice planes in the graphene or derivative thereof is from 0.34 nm to 1000 nm, such as from 0.34 nm to 500 nm, or from 0.4 nm to 500 nm, or from 0.4 nm to 250 nm, such as from 0.4 nm to 200 nm, or from 0.4 nm to 150 nm, or from 0.4 nm to 100 nm, or from 0.4 nm to 50 nm, or from 0.4 nm to 25 nm, or from 0.4 nm to 10 nm, or from 0.4 nm to 5 nm, such as from 0.45 nm to 4 nm, from 0.5 nm to 3 nm, 0.55 nm to 2 nm, or 0.55 nm to 1.5 nm, or 0.6 nm to 1.2 nm, for example 0.6 nm to 1.1 nm, 0.6 nm to 1 nm, 0.6 nm to 0.9 nm, or 0.6 nm to 0.8 nm.

The coating may comprise materials, suitably two-dimensional materials, other than graphene or derivatives thereof. For example, other materials of the coating may be selected from one or more of silicene, germanene, stanene, boron-nitride, suitably h-boron nitride, carbon nitride, metal-organic nanosheets, molybdenum disulfide, and tungsten disulfide, polymer/graphene aerogel.

The materials of the coating may be produced using any of the suitable methods known to the skilled person. Two-dimensional silicene, germanene and stanene may be produced by surface assisted epitaxial growth under ultrahigh vacuum. Hexagonal two-dimensional h-boron nitride may be produced by several methods, such as mechanical cleavage, unzipping of boron nitride nanotubes, chemical functionalisation and sonication, solid-state reaction and solvent exfoliation and sonication. Among these methods, chemical method has been found to provide the highest yield. For example, h-boron nitride may be synthesised on single-crystal transition metal substrates using borazine as boron and nitride sources. Two-dimensional carbon nitride can be prepared via direct microwave heating of melamine and carbon fibre. Metal-organic frameworks (MOFs) can be produced by in-situ solvothermal synthesis method by mixing ingredients at high temperatures such as 100-140° C., followed by filtration. Two-dimensional molybdenum disulfide can be obtained by a few methods, such as mechanical exfoliation, liquid exfoliation and chemical exfoliation. Among these methods, chemical exfoliation has been found to provide a high yield. One example is chemical exfoliation using lithium to chemically exfoliate molybdenum disulfide using centrifuge and filtration. Two-dimensional tungsten disulfide can be prepared by a deposition-thermal annealing method: vacuum deposition of tungsten and followed by thermal annealing by addition of sulphur. Polymer/graphene aerogel can be produced via coupling and subsequent freeze-drying using polyethylene glycol grafted graphene oxide.

The method of applying the coating composition to the membrane substrate may comprise the step of applying a coating composition comprising the graphene or derivative thereof onto the substrate. The method may comprise contacting the coating composition onto the substrate using gravity deposition, vacuum deposition, pressure deposition; printing such as inkjet printing, aerosol printing, 3D printing, offset lithography printing, gravure printing, flexographic printing techniques, pad printing; curtain coating, dip coating, spin coating, and other printing or coating techniques known to those skilled in the art.

Further details of the application methods are disclosed in the published PCT patent application WO2019106344, specifically, paragraphs to and to inclusive. The entire contents of paragraphs to and to inclusive thereof are fully incorporated herein by reference.

The coating composition may be a liquid composition comprising a liquid medium and the graphene or derivative thereof. The coating compositions of the present invention may comprise solvent, non-solvent or solvent-less, and may be UV curable compositions, e-beam curable compositions etc. When formulated as a liquid composition for use in the invention, e.g. as a solution, dispersion or suspension, a suitable carrier liquid or solvent may be aqueous or organic, and other components will be chosen accordingly. For example, the liquid carrier may comprise water or an organic solvent such as ethanol, terpineol, dimethylformamide N-Methyl-2-pyrrolidone, isopropyl alcohol, mineral oil, ethylene glycol, or their mixtures, optionally with other materials to enhance performance and/or rheology of the composition including any one or more of binders, drying additives, antioxidants, reducing agents, lubricating agents, plasticisers, waxes, chelating agents, surfactants, pigments, defoamers and sensitisers.

Further details of the coating composition are disclosed in published PCT patent application WO2019106344, specifically, paragraphs to inclusive. The entire contents paragraphs to inclusive thereof are fully incorporated herein by reference.

The coating may comprise a lamellar structure comprising at least two layers of two-dimensional material, and wherein the two-dimensional material comprises a transition metal dichalcogenide. The coating may be formed from a coating composition comprising a transition metal dichalcogenide.

The transition metal dichalcogenide may be according to formula (I)

MₐX_{b}. (I)
wherein with M is a transition metal atom, such as Mo, W, Nb and Ni;
X is a chalcogen atom, preferably S, Se, or Te;
wherein 0<a≤1 and 0<b≤2.

The transition metal dichalcogenide may be selected from one or more of MoS₂, MoSe₂, WS₂, WSe₂, MoₐW₁₋ₐS₂, MoₐW₁₋ₐSe₂, MoS_{b}Se_{2-b}, WS_{b}Se_{2-b}, or MoₐW₁₋ₐS_{b}Se_{2-b}, where 0<a≤1 and 0<b≤2, or combination thereof. Preferably, the transition metal dichalcogenide is selected from MoS₂, WS₂, MoSe₂, WSe₂. Most preferably from MoS₂ and WS₂. Such transition metal dichalcogenide is available commercially from ACS Material.

The transition metal dichalcogenide may be in the form of flakes having an average size of from 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm. Suitably, the size distribution of the transition metal dichalcogenide flakes is such that at least 30 wt % of the transition metal dichalcogenide flakes have a diameter of between 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm more preferably at least 40 wt %, 50 wt %, 60 wt %, 70 wt % and most preferably at least 80 wt % or at least 90 wt % or 95 wt % or 98 wt % or 99 wt %. The size of the transition metal dichalcogenide thereof and size distribution may be measured using transmission electron microscopy (TEM, JEM-2100F, JEOL Ltd. Japan).

For example, lateral sizes of the two-dimensional layers across a sample may be measured using transmission electron microscopy (TEM, JEM-2100F, JEOL Ltd. Japan), and the number (Nᵢ) of the same sized nanosheets (Mᵢ) measured. The average size may then be calculated by Equation 1:

$$Average size = {\sum }_{i = 1}^{∞} {N}_{i} {M}_{i} / {\sum }_{i = 1}^{∞} {N}_{i}$$

where Mᵢ is the diameter of the nanosheets, and Nᵢ is the number of the size with diameter Mᵢ.

The transition metal dichalcogenide may be in the form of a monolayer or multi-layered particle or flake, preferably a monolayer. The transition metal dichalcogenide flakes may be formed of single, two or few layers of transition metal dichalcogenide, wherein few may be defined as between 3 and 100 layers. Suitably, the transition metal dichalcogenide flakes comprise between 1 to 100 layers, such as between 2 to 75 layers or 5 to 50 layers or 10 to 25 layers. Suitably, at least 30 wt % of the transition metal dichalcogenide comprise between 1 to 30 layers, such as between 5 to 30 layers or 5 to 10 layers, more preferably at least 40 wt %, 50 wt %, 60 wt %, 70 wt % and most preferably at least 80 wt % or at least 90 wt % or 95 wt % or 98 wt % or 99 wt %. The number of layers in the transition metal dichalcogenide flakes thereof may be measured using atomic force microscopy (AFM or transmission electron microscopy (TEM)) (TT-AFM, AFM workshop Co., CA, USA).

Suitably, the d-spacing between adjacent lattice planes in the transition metal dichalcogenide or mixture thereof is from 0.34 nm to 5000 nm, such as from 0.34 nm to 1000 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 10 nm, or from 0.4 to 8 nm, such as from 0.4 to 7 nm, from 0.45 to 6 nm, 0.50 to 5 nm, or 0.55 to 4 nm, or 0.6 to 3 nm, for example 0.6 to 2.5 nm, 0.6 to 1 nm, 0.6 to 2 nm, or 0.6 to 1.5 nm.

The coating may comprise materials, suitably two-dimensional materials, other than the transition metal dichalcogenide thereof. For example, other materials of the coating may be selected from one or more of silicene, germanene, stanene, boron-nitride, suitably h-boron nitride, carbon nitride, metal-organic nanosheets, graphene, graphene oxide, reduced graphene oxide functionalised graphene oxide and polymer/graphene aerogel.

Further details of the application methods are disclosed in published PCT patent application WO2019/122828, specifically, paragraphs [73] to [77] inclusive. The entire contents paragraphs [73] to [77] inclusive thereof are fully incorporated herein by reference.

Further details of the coating composition are disclosed in published PCT patent application WO2019/122828, specifically, paragraphs [46] to [61] inclusive. The entire contents paragraphs [46] to [61] inclusive thereof are fully incorporated herein by reference.

The coating may comprise a metal-organic framework (MOF). The coating may be formed from a coating composition comprising a MOF.

The metal-organic framework materials of any aspect of the present invention may be one-dimensional, two-dimensional or three-dimensional. Preferably, the MOF is porous. The MOF may comprise a network of secondary building units (SBUs), or metal ion core/metal subunit cluster core nodes, and organic linkers (or ligands) connecting the SBUS or nodes.

The MOF may be in continuous phase in the coating or may be in the form of flakes and/or particles. A MOF synthesised in the presence of first support portion may be in the form of continuous phase. A MOF formed prior to contact with the first support portion may be in the form of flakes and/or particles.

The SBUs or nodes, being sub units of the MOF, may comprise metal selected from one or more transition metal cations, such as one or more of Cr(III), Fe(II), Fe(III), Al(III), Co(II), Ru(III), Os(III), Hf(IV), Ni, Mn, V, Sc, Y(III), Cu(II), Cu(I), Zn(II), Zr(IV), Cd, Pb, Ba, Ag(I), Au, AuPd, Ni/Co, lanthanides, actinides, such as Lu, Tb(III), Dy(III), Ho(III), Er(III), Yb(III). Preferably Cr(III), Fe(II), Fe(III), Al(III), Co(II), Ru(III), Os(III), Hf(IV), Ni, Mn, V, Sc, Y(III), Cu(II), Cu(I), Zn(II), Zr(IV), Cd, Pb, Ba, Ag(I), Ni/Co, lanthanides, actinides, such as Lu, Tb(III), Dy(III), Ho(III), Er(III), Yb(III). More preferably Cr(III), Fe(II), Fe(III), Al(III), Co(II), Hf(IV), Ni, Mn, V, Sc, Y(III), Cu(II), Cu(I), Zn(II), Zr(IV), Cd, Pb, Ag(I), Ni/Co, lanthanides, actinides, such as Lu, Tb(III), Dy(III), Ho(III), Er(III), Yb(III), more preferably Cr(III), Fe(II), Fe(III), Al(III), Co(II), Hf(IV), Ni, Mn, V, Y(III), Cu(II), Cu(I), Zn(II), Zr(IV), Cd, Ag(I), Ni/Co, lanthanides, actinides, such as Lu, Tb(III), Dy(III), Ho(III), Er(III), Yb(III). The secondary building unit (SBU) may comprise: three, four, five, six, eight, nine, ten, eleven, twelve, fifteen or sixteen points of extension.

The SBU or node may be a transition-metal carboxylate cluster. The SBUs or nodes may be one or more selected from the group consisting of Zn4O(COO)6, Cu2(COO)4, Cr3O(H2O)3(COO)6, and Zr6O4(OH)10(H2O)6(COO)6), Mg2(OH2)2(COO), RE4(μ3-O)2(COO)8, RE4(μ3-O)2, wherein RE is Y(III), Tb(III), Dy(III), Ho(III), Er(III), and/or Yb(III). The structures of SBUs can be identified by X-Ray diffraction using methods well known to the skilled person.

Organic linkers suitable for use in the present invention include those operable to be used to form MOFs for water treatment, molecule separation, and biofiltration related applications. Such linkers may form strong bonds to metal cores, provide large pore sizes, provide high porosity, provide selective absorption and/or capacity.

The organic linkers of the MOF may be formed from a wide range of organic molecules, such as one or more carboxylate linkers; N-heterocyclic linkers; phosphonate linkers; sulphonate linkers, metallo linkers, such a carboxylate-metallo linkers; and mixtures and derivatives thereof.

The organic linkers may comprise one or more of ditopic, tritopic, tetratopic, hexatopic, octatopic linkers. The organic linkers may comprise desymmetrised linkers.

MOFs suitable for use in the present invention include those operable to be used in water treatment, molecule separation, biofiltration and related applications. Suitable MOFs preferably have water and chemical stability. The MOFs may have water insoluble linkers, and/or solvent-stable linkers, and/or strong covalent bonds between SBU and linkers, and/or multi-covalent bonds between SBU and linkers. Water and chemical stability may mean that the MOFs do not fully disassemble to linkers and SBUs in the presence of water and/or chemicals. Suitable MOFs may have covalent bond links between the linkers and the SBUs or nodes, and/or coordinate bonding between the linkers and the SBUs or nodes.

Suitable MOFs may have a high surface area and/or large pore sizes. The MOF may have a surface area of at least 10 m²/g, such as 100 to 9,000 m²/g, preferably 100 to 8,000 m²/g or 500 to 8,000 m²/g. The surface area can be measured using the known Brunauer, Emmett and Teller (BET) technique. The MOFs according to any aspect of the present invention, suitably in the form of porous flakes or particles, may have an average pore size of from 0.1 nm to 1000 nm, 0.1 to 950 nm, 0.2 to 900 nm, 0.2 to 850 nm, preferably 0.2 to 800 nm, 0.3 to 700 nm, preferably 0.4 to 650, 0.4 to 550 nm, 0.5 to 500 nm, 0.5 to 450 nm, 0.2 nm to 100 nm, such as between 0.2 nm to 90 nm, 0.3 nm to 75 nm, 0.4 nm to 50 nm, for example 0.4 nm to 40 nm, 0.4 nm to 30 nm, or 0.4 nm to 20 nm, suitably 0.4 nm to 15 nm, 0.4 nm to 10 nm.

The MOF may comprise a pillared-layer MOF. Suitably, in a pillared-layer MOF 2D sheets function as scaffolds for organic linkers, such as dipyridyl linkers. Advantageously, this can allow for diverse functionalities to be incorporated into the MOF, such as —SO₃²⁻ groups. The use of —SO₃²⁻ groups can induce a polarized environment and strong acid-base interaction with acidic guests like CO₂. Furthermore, different pillar linker groups, such as —N═N— compared to —CH═CH—, provide different selectivity to H₂O and methanol.

The MOF may comprise a functional group. The MOF may in particular be adapted for water treatment, molecule separation, and biofiltration related applications by the MOF comprising a functional group, suitably on one or more of the organic linkers. Said functional groups may provide selectivity and/or increase pore sizes for high adsorption capacity or high flux rate. The functional group may be selected from one or more of the group consisting of —NH₂, —Br, —Cl, —I, —(CH₂)ₙ—CH₃ wherein n is 1 to 10, such as CH₃CH₂CH₂O—, CH₃CH₂CH₂CH₂O—, ben-C₄H₄, methyl, —COOH, —OH. For example, the MOF may be an IRMOF, such as IRMOF-1, IRMOF-2, IRMOF-3, IRMOF-4, IRMOF-5, IRMOF-6, IRMOF-7, IRMOF-8, IRMOF-9, IRMOF-10, IRMOF-16, IRMOF-11, IRMOF-12, IRMOF-13, IRMOF-14, IRMOF-15; and/or a CAU, such as CAU-10-OH, CAU-10-NH₂, CAU-10-H, CAU-10-CH₃; and/or MIL-125-NH2; and/or UiO-66(Zr)—(CH3)2.

The coating may be operable to provide size exclusion filtration, fouling resistance, and/or adsorption, such as size exclusion and fouling resistance.

The pore size of the MOF may be tailored by using different species of MOFs or different organic linkers with different lengths. For example, the pore size of the MOF may be at least 0.6 nm (e.g. ZIF-78), such as at least 0.8 nm (e.g. ZIF-81), or at least 0.9 nm (e.g. ZIF-79) or at least 1.2 nm (e.g. ZIF-69), or at least 1.3 nm (e.g. ZIF-68) or at least 1.6 nm (e.g. ZIF-82), such as at least 1.8 nm (e.g. ZIF-70), or at least 1.8 nm (e.g. IRMOF-10), or at least 2.8 nm (e.g. MOF-177).

The MOF may comprise MOF-74 adapted by replacing one or more of the original linkers containing one phenyl ring with a linker containing two, three, four, five, six, seven, nine, ten or eleven phenyl rings. Such an adaption can alter the pore size from ˜1.4 nm to ˜2.0 nm, to ˜2.6 nm, to ˜3.3 nm, to ˜4.2 nm, to ˜4.8 nm, to ˜5.7 nm, to ˜7.2 nm, to ˜9.5 nm, respectively.

The MOF may be hydrophobic. The hydrophobic MOF may be selected from one or more of MIL-101(Cr), NiDOBDC, HKUST-1, Al(OH)(2,6-ndc) (ndc is naphthalendicarboxylate), MIL-100-Fe, UiO-66, ZIF family, such as ZIF 71, ZIF 74, ZIF-1, ZIF-4, ZIF-6, ZIF-11, ZIF-9, and ZIF 8. Advantageously, the use of such MOFs can improve the fouling resistance of the membrane.

The MOF may comprise an adsorption promoting MOF, for example UiO-66 or UiO-66-NH2, preferably UiO-66-NH2, which has been found to adsorb cationic dyes from aqueous solution more effectively than anionic dyes due to favourable electrostatic interactions between the adsorbents and cationic dyes. In particular, UiO-66-NH2 has been found to provide much higher adsorption capacity for cationic dyes and lower adsorption capacity for anionic dyes than UiO-66.

The MOFs may comprise nanochannels, suitably the MOFs are in the form of flakes or particles comprising nanochannels. The average nanochannel diameter may be from 0.2 nm to 100 nm, such as between 0.2 to 90 nm, 0.3 nm to 75 nm, 0.4 nm to 50 nm, for example 0.5 nm to 40 nm, 0.5 nm to 30 nm, or 0.5 nm to 20 nm, suitably 0.5 nm to 15 nm, 0.5 nm to 10 nm or preferably 0.5 nm to 8 nm.

The MOF may comprise functional groups selected from one or more of amine, aldehyde, alkynes, and/or azide. MOFs pores may be modified for selective sieving and to provide higher efficiency by modification methods, suitably post-synthetic, on the linkers and/or the secondary building units/nodes, such as covalent post-synthetic modification method of amine, or aldehyde, or alkynes, or azides functional groups. Specific functional groups may be induced to MOF(s) for specific application. For example, adding —NH2 to UiO-66 to make UiO-66-NH2 has been found to improve ferric acid adsorption, and adding sulfone bearing groups to iso IRMOF-16 by, for example, oxidation using dimethyldioxirane, in order to create compatible interaction between the coating and first support portion.

The MOFs of the present invention may be synthesised according to the required property or purchased from commercial supplier. Suitable commercially available metal-organic framework materials can be purchased from BASF, Sigma-Aldrich, or Strem Chemicals.

The methods used to synthesise MOFs for the current invention are those conventional in the art and may be solvothermal synthesis, microwave-assisted synthesis, electrochemical synthesis etc.

A modulator may be used during synthesis of the MOF to control the MOF particle size, the modulator may be benzoic acid.

The MOF may be in the form of a crystallised continuous phase or particles or flakes compacted and interacting or fused to each other forming the coating. Preferably the MOF is in the form of particles or flakes.

The size distribution of the MOF flakes or particles may be such that at least 30 wt % of the MOF flakes or particles have a size of between 1 nm to 10000 nm, such as between 2 to 7500 nm, 5 nm to 5000 nm, 10 nm to 4000 nm, for example 15 nm to 3500 nm, 20 nm to 3000 nm, or 25 nm to 3000 nm, suitably 30 nm to 2500 nm, 40 nm to 2500 nm or preferably 50 nm to 2500 nm more preferably at least 40 wt %, 50 wt %, 60 wt %, 70 wt % and most preferably at least 80 wt % or at least 90 wt % or 95 wt % or 98 wt % or 99 wt %. The size of the MOF and size distribution may be measured using transmission electron microscopy (TEM, JEM-2100F, JEOL Ltd. Japan).

For example, lateral sizes of two-dimensional layers across a sample of a MOF may be measured using transmission electron microscopy (TEM, JEM-2100F, JEOL Ltd. Japan), and the number (Ni) of the same sized nanosheets (Mᵢ) measured. The average size may then be calculated by Equation 1:

$$Average size = {\sum }_{i = 1}^{∞} {N}_{i} {M}_{i} / {\sum }_{i = 1}^{∞} {N}_{i}$$

where Mᵢ is diameter of the nanosheets, and Nᵢ is the number of the size with diameter Mᵢ.

The coating may comprise additives to tailor the properties of the coating, such as other metals; and/or fibres, such as metal oxide nanostrands; and/or dopants such as Au, Fe, Cu, Cu(OH)₂, Cd(OH)₂ and/or Zr(OH)₂. Such additives may be added to the membrane to control the pore sizes and channel architecture of MOF and/or create nanochannels for high water flux rate. Any type of suitable fibres, such as continuous or stapled fibres, having diameter of 0.1-1000 nm may be incorporated within the membrane. Such as 0.1 to 850 nm, 0.5 to 500 nm, or 0.5 to 100 nm, 0.75 to 75 nm, preferably, 0.75 to 50 nm. Suitably, the fibres are removed before use, such as by mechanical removal or by dissolution, etc.

Further details of the application methods are disclosed in the published PCT patent application WO2019/186134, specifically, paragraphs [117], [118] and [126] to [130] inclusive. The entire contents of paragraphs [117], [118] and [126] to [130] inclusive thereof are fully incorporated herein by reference.

Further details of the coating composition are disclosed in the published PCT patent application WO2019/186134, specifically, paragraphs [97] to [116] inclusive. The entire contents of paragraphs [97] to [116] inclusive thereof are fully incorporated herein by reference.

The coating may further comprise nanochannels formed by the use of fibres in the production of the membrane. Advantageously the presence of nanochannels within the coating have been found to significantly increase the water flux by incorporating continuous or chopped fibres having diameter of 0.5-1000 nm during the manufacture process followed by removal of the fibres.

The nanochannels in the coating may have a diameter of 1 to 750 nm, such as 1 to 500 nm, or 1 to 250 nm, for example 1 to 150 nm or 1 to 100 nm, for example 1 to 50 nm or 1 to 25 nm, such as 1 to 10 nm or preferably 1 to 5 nm.

The two-dimensional material of the coating may be treated two-dimensional material. The two-dimensional material may be treated after formation of the coating on the membrane substrate. The treatment may cause a change to the functional groups of the two-dimensional material, such as by application of high energy radiation such as laser radiation, chemicals, heat, thermal heat and/or pressure to the two-dimensional material.

The two-dimensional material may be treated, suitably reduced, by exposing the two-dimensional material to radiation, such as laser radiation, microwave radiation, UV radiation, E-beam radiation, plasma treatment, electron radiation, soft X-ray radiation, gamma radiation, alpha radiation; chemical treatment, pressure treatment and/or thermal treatment, preferably, laser radiation and/or plasma treatment.

The coating may comprise multiple coating layers, wherein at least one of the layers was treated before deposition of a subsequent layer. Preferably, each layer was treated before deposition of the subsequent layer. The layers of coating comprising multiple coating layers may have been subjected to different treatments, in terms of the type of treatment and/or the extent of the treatment. As such, at least one of the layers may comprise two-dimensional material having different functionality to another layer. For example, the layers may comprise a gradient of decreasing reduction level in the two-dimensional material from the top of the coating layer towards the bottom of the coating layer adjacent to the substrate. The gradient may be created in the reverse direction.

The presence of the gradient may increase the adhesion between the coating and substrate, and may also increase the fouling resistance of the overall membrane.

Treatment of the two-dimensional material on the substrate may cause a change in the functional groups of the two-dimensional material, for example changed the number, species and/or distribution of the functional groups. For example, treatment may reduce the two-dimensional material and/or may functionalise the two-dimensional material by adding functionality to the two-dimensional material.

Treatment of the two-dimensional material thereof to functionalise the two-dimensional material may add or change the functional groups of the two-dimensional material, for example by reaction with existing hydroxyl, carboxylic and/or epoxide groups of the two-dimensional material. Functionalisation includes covalent modification and non-covalent modification. Covalent modification method can be subcategorised to nucleophilic substitution reaction, electrophilic substitution reaction, condensation reaction, and addition reaction.

The two-dimensional material may be treated, suitably reduced, by exposing the two-dimensional material to radiation, such as laser radiation, microwave radiation, UV radiation, E-beam radiation, plasma treatment, electron radiation, soft X-ray radiation, gamma radiation, alpha radiation; chemical treatment and/or thermal treatment. Preferably, laser radiation and plasma treatment.

Chemical, thermal or radiation treatment of the two-dimensional material on the substrate can be used to form chemically reduced GO (CRGO), thermally reduced graphene oxide (TRGO) or radiation reduced graphene oxide (RRGO).

The hydrophilicity of the treated membrane may be controlled by the functional groups or polar atom percentage, such as oxygen or nitrogen left at the surface after treatment.

The prefiltration portion and/or nanofiltration separation portion of the present invention, and/or the concentration portion, may comprise a membrane comprising a porous ceramic member, wherein the porous ceramic member comprises a first support portion operable to support a coating and further comprises a second support portion, wherein the second support portion has a higher D₇₅ average pore size than the D₇₅ average pore size of the first support portion, wherein the second support portion comprises a lattice structure that has a porosity percentage of ≥40%, and wherein the porous ceramic member has a tensile strength operable to withstand feed application pressure of ≥100 kPa (1 bar). The membrane comprising a porous ceramic member may further comprise a coating supported on the porous ceramic member, specifically, wherein the coating extends across at least a portion of the first support portion.

In the present invention, a membrane comprising the porous ceramic member may have thinner walls due to an additively manufactured porous ceramic lattice structure which allows increased packing density of membrane structures, creating more active surface area within the membrane. Thinner membrane walls also lead to less dead-end pores and a less tortuous pathway, increasing flux across the membrane.

The first support portion may have an average thickness of ≥10 μm, such as ≥20 μm, ≥30 μm, ≥40 μm, such as ≥50 μm. The first support portion may have an average thickness of ≤1000 μm, such as ≤800 μm, ≤600 μm, $400 μm, such as ≤200 μm. The first support portion may have an average thickness of from between 10 μm to 1000 μm, such as from 20 to 800 μm or from 30 to 600 μm, such as 40 to 400 μm or 50 to 200 μm, such as 50 to 150 μm or 50 to 100 μm. The first support portion as referred to herein, may refer to a ceramic surface between the feed inlet side and the permeate outlet side.

The second support portion may be operable to produce substantially laminar flow towards a permeate collection point.

The second support portion may comprise turbulent flow paths. Advantageously, this allows better homogenisation of fluid content.

The membrane of the present invention may comprise a feed flow channel, suitably a plurality of feed flow channels, such as a plurality of substantially linear, and optionally substantially parallel feed flow channels. The feed flow channel may be substantially cylindrical.

The average width/diameter of the feed flow channel may be ≥0.1 mm, such as ≥0.3 mm or ≥0.5 mm. The “width” in the present context is intended to mean the largest lateral dimension of the channel. The average width/diameter of the feed flow channel may be ≤10 mm, such as ≤7 mm or ≤5 mm. The average width/diameter of the feed flow channel may be from 0.1 to 10 mm, such as from 0.3 to 7 mm or from 0.5 to 5 mm.

The membrane may comprise at least two feed flow channels that are spaced along at least a portion of their lengths by the first and second support portions, for example spaced by two first support portions with a second support portion arranged between the two first support portions.

The membrane may comprise a channel pitch, such an average pitch, of ≤14 mm, such as ≤10 mm or ≤7 mm. The membrane may comprise a channel pitch, such an average pitch, of ≥0.13 mm, such as ≥0.36 mm or ≥0.59 mm. The membrane may comprise a channel pitch, such an average pitch, of from 0.13 mm to 14 mm, such as from 0.36 mm to 10 mm or from 0.59 to 7 mm. As used herein, “channel pitch” refers to the distance between two adjacent feed channels as measured from the centre points of the feed channels.

The membrane may have a membrane packing density, such as a coating packing density, of ≥200 m²/m³, such as ≥350 m²/m³, such as ≥500 m²/m³.

Packing density may be calculated by any suitable method known to the skilled person. In general terms:

$$Packing density = \frac{membrane surface area}{F ilter volume}$$

For example, when the membrane comprises cylindrical feed flow channels that packing density may be calculated as follows;
   Dimensional measurements are made of:
r_{c}=Single channel radius
L=Channel length
rₜ=Ceramic filter radius
Lₜ=Ceramic filter length

$$\begin{matrix}C = 2 \times π \times {r}_{c} \\ V = {L}_{f \times } π \times {{r}_{f}}^{2}\end{matrix}$$

C=Channel Circumference
L_{c}=Channel length
N=number of channels
V=ceramic filter volume

$$Packing density = \frac{N \times C \times {L}_{c}}{V}$$

The feed flow channel may extend into the porous ceramic member, suitably extend through the porous ceramic member, such as from one side of the porous ceramic member/membrane to a substantially opposed side of the member/device. The channel may be a cylindrical channel.

The flow channel may be integrally formed with the first and second support portions. The flow channel may comprise a channel wall formed at least partially of the first support portion, which may optionally comprise a coating arranged at least partially thereon the internal surface of the channel. The feed flow channel wall may be substantially formed by the first support member, optionally with a coating arranged at least partially thereover. Feed flowing through the channel may be operable to pass through the optional coating and the first support portion to thereby be filtered and form permeate flow through the second support portion and then flow out of the porous ceramic member to a permeate collection point. The second support portion may be shelled to provide a secondary permeate flow path through the porous ceramic member to the permeate collection point.

A “lattice structure” as referred to herein, means a three-dimensional structure composing one or more repeating unit cells, wherein the cells are interconnected such as to allow for fluid flow to adjacent cells. Triply period surfaces are included as part of the term “lattice”.

The lattice structure may comprise a unit cell that has a unit cell size of ≥0.01 mm, such as ≥0.1 mm, or ≥0.25 mm. The lattice structure may comprise a unit cell that has a unit cell size of ≤10 mm, such as ≤7 mm, or ≤5 mm.

The lattice structure may comprise a unit cell having a diamond structure, a cubic structure, a fluorite structure, an octet structure, a Kelvin cell structure, an iso-truss structure, a hex prism diamond structure, a truncated tube structure, a truncated octahedron structure, a Weaire-Phelan structure, a body centred cubic structure, and/or a face centred cubic structure. Optionally, the lattice structure may comprise a unit cell having a TPMS structure selected from a gyroid structure, a schwarz P structure, a schwarz D structure, a schwarz CLP structure, a schwarz H structure, a splitP structure, a neovius structure, or a double gyroid structure.

The second support portion may comprise a non-uniform lattice structure. Non-uniform lattice refers to a lattice structure where one or more type of unit cell is different from another type of unit cell in the overall lattice structure. Lattice non-uniformity may arise due to one or more different structural features. For example, a difference in the thickness of the lattice struts; a difference in the void space of the lattice unit cells; and/or a difference in the shape of the lattice unit cells.

The non-uniform lattice may comprise a gyroid structure with a gradient, suitably a linear gradient, changing bias length; a gyroid structure with (linear) gradient changing wall thickness; and/or a diamond lattice structure with (linear) gradient changing strut thickness.

The porous ceramic member may have a tensile strength operable to withstand feed application pressure of ≥0.5 MPa, such as ≥1 MPa or ≥2 MPa, optionally, in the range of 2 MPa to 200 GPa. As used herein, “operable to withstand feed application pressure” means that the porous ceramic member is operable to substantially function as required in the membrane at the given pressure substantially without damage to the structure of the porous ceramic member. As used herein, tensile strength was measured using a 3-point bend test.

A non-uniform lattice may comprise different lattice cell shapes.

When the second support portion comprises a non-uniform lattice structure, the average thickness of the second support portion may be from between 10 to 2000 μm.

Advantageously, a non-uniform lattice can be thicker in only the areas which require strength, thus reducing the amount of material used. The thickness also has a direct impact on the porosity, with thicker areas having a lower porosity and thinner areas having a higher porosity. A higher porosity means more area for liquid to move through, increasing the flux, so having only thickening areas where required, means higher porosity in the overall porous ceramic member.

The lattice unit cell may be shelled to form an internal hollow structure. At least a portion of the internal structure may form a series of interconnected voids with other shelled unit cells. This internal series of interconnected voids may be operable to provide a further conduit for the permeate to pass through. Advantageously, the interconnecting voids increase the overall porosity of the support portion while maintaining the required strength. The interconnecting voids may increase the porosity of the second support portion by about 5 to 15%, such as an increase in porosity of 10%. Suitably, the second support portion may have a porosity percentage of ≥45%, such as ≥50%, or ≥55%. The internal interconnected voids further add to the reduction of material used in the manufacturing of the membrane, reducing the weight and cost.

The porous ceramic member, the first support portion and/or the second support portion may be formed from a composition comprising a ceramic material that may comprise alumina, titania, zirconia, silicon carbide, hydroxyapatite, silicates, zeolite, metal oxides, or combinations thereof. The ceramic material may comprise alumina, titania, zirconia, silicon carbide, hydroxyapatite, silicates, zeolite, metal oxides, or combinations thereof. The first and second support portions comprise the same or different ceramic material.

The composition may comprise further additives. For example, the composition may comprise a pore forming agent (PFA), such as wheat particles, starch, PMMA, poppy seed and saw dust, a functionalising agent, a nano-material, a metal-organic framework and/or a two dimensional material such as a transition metal dichalcogenide and/or graphene oxide.

The second support portion may have any suitable D₇₅ average pore size. Preferably, the second support portion may be macroporous. The D₇₅ average pore size of the second support portion may be ≥0.1 mm, such as ≥0.2 mm, such as ≥0.3 mm, such as ≥0.4 mm. The D75 average pore size of the second support portion may be ≤5 mm, such as $4 mm, such as ≤3 mm, such as ≤2 mm, such as ≤1 mm. The D75 average pore size of the second support portion may be from about 0.1 to 5 mm, such as from about 0.2 to 4 mm, such as about 0.3 to 3 mm, such as about 0.4 to 1 mm.

The first support portion may have any suitable D75 average pore size. The D75 average pore size of the first support portion may be dictated by the components of the ceramic composition used, and the process of sintering the ceramic composition. The D₇₅ average pore size of the first support portion may be from 0.05 to 20 μm, depending on the application. For example, the first support portion D₇₅ average pore size may change depending on whether the application relates to particle-filtration, micro-filtration, nano-filtration, and reverse osmosis-filtration. The first support portion may typically be microporous. Typically, the D₇₅ average pore size of the first support portion may be ≥1 μm, such as ≥2 μm, such as ≥3 μm, such as ≥5 μm. The D₇₅ average pore size of the first support portion may be ≤20 μm, such as ≤15 μm, such as ≤10 μm. The D75 average pore size of the first support portion may be from about 1 to 20 μm, such as about 2 to 15 μm, or about 3 to 10 μm.

The D₇₅ average pore size may be measured according to methods well known to the skilled person, such as by mercury intrusion porosimetry.

The first support portion may have a porosity percentage of ≥5%, such as ≥10%, such as ≥15% porosity. The first support portion may have a porosity percentage of ≤50%, such as ≤40%, typically, ≤35% porosity. The first support portion may have a porosity percentage of between about 5 to 50%, such as 10 to 40%, such as 15 to 35% porosity.

The second support portion may have a porosity percentage of ≥45%, such as ≥50%, such as ≥55%, such as ≥60%. The second support portion may have a porosity percentage of ≤80%, such as ≤75%, such as ≤70%. The second support portion may have a porosity percentage of between about 40 to 80%, preferably, about 60 to 80%, such as 70% porosity.

The porosity is a measurement of the void space of a structure wherein the solid volume of the structure is divided by the total volume occupied dimensionally by the structure, expressed as a percentage.

$$n = ( 1 - \frac{{V}_{S}}{{V}_{T}} ) \times 100$$

where Vₛ is the solid and V_{T} is the total volume.

The first and second support portions may be integrally formed so as to form a continuous structure. Suitably, the first and second support portions are integrally formed by additive manufacturing.

The membrane of the present invention may be produced by:
a. additively manufacturing the porous ceramic member to produce the lattice structure of the second support portion and to form the first support portion;
b. optionally, removing binder from the first support portion to form pores in the first support portion;
c. optionally, applying a coating to at least a portion of the first support portion, suitably by coating a coating composition onto the first support portion.

In step (a) the macrostructure of the first support portion may be formed but the pore structure of the first support portion may be formed in step (b). In such a process, step (a) may be considered to be the formation of the green part. Step (b) may be considered to be a de-binding and/or sintering step.

Advantageously, the first and/or second support portion may be produced, suitably printed, using an additive manufacturing process, preferably, the first and second support portions are additively manufactured so as to form an integral support structure. The additive manufacturing technique may be any suitable ceramic 3D printing technology. For example, the first and/or second support portion may be printed using binder jet printing, stereolithography, digital light processing, two-photon polymerisation, inkjet printing, direct ink writing, three-dimensional printing, selective laser sintering, selective laser melting, laminated object manufacturing, or fused deposition modelling.

The additive manufacture of the porous ceramic member provides a membrane with the mechanical strength required to support a coating during manufacture and filtration, whilst also balancing the high porosity and increased packing density to provide improved fluid flow during the final filter application.

In the membrane of the present invention, pressure is used to push the water through the coating where contaminates are separated out and left in the water feed and uncontaminated water passes through onto the permeate side, where it is pushed through the porous ceramic member towards an exit of the membrane.

The term “shelled” referred to herein, means hollowed solid parts of a structure with a given wall thickness.

The prefiltration portion, a separation portion, such as the first separation portion, the nanofiltration separation portion and/or the concentration portion, may comprise a spiral wound membrane, such as a spiral wound membrane having a component comprising an integrally formed non-uniform lattice structure, wherein the lattice structure comprises a first and second repeating unit cell, wherein the first and second unit cells are different.

The spiral membrane component may be a feed flow carrier, permeate carrier, a backing layer or a combined permeate-backing layer.

The second repeating unit cell may have a different size compared to the first repeating unit cell.

The second repeating unit cell may have a different pore size compared to the first repeating unit cell.

The spiral wound membrane may comprise a backing layer component comprising an integrally formed lattice structure, wherein the lattice structure comprises a repeating unit cell.

The pore size of the first and/or second unit cell, when present, of the lattice structure may be ≥10 μm, such as ≥20 μm, such as ≥30 μm. The pore size of the first and/or second unit cell, when present, of the lattice structure may be ≤5 mm, such as ≤4 mm, such as ≤3 mm.

The pore size of the first and/or second unit cell, when present, of the lattice structure may be ≥40 μm, such as ≥50 μm. The pore size of the first and/or second unit cell, when present, of the lattice structure may be ≤1 mm, such as ≤0.5 mm.

The second repeating unit cell may have a different strut thickness compared to the first repeating unit cell. The average strut thickness of the first and/or second unit cell, when present, of the lattice structure may be ≥10 μm, such as ≥20 μm, such as ≥30 μm. The average strut thickness of the first and/or second unit cell, when present, of the lattice structure may be ≤5 mm, such as ≤4 mm, such as ≤3 mm.

The average strut thickness of the first and/or second unit cell, when present, of the lattice structure may be ≥40 μm, such as ≥50 μm. The average strut thickness of the first and/or second unit cell, when present, of the lattice structure may be ≤1 mm, such as ≤0.5 mm.

The average thickness of the component may be ≤850 μm, such as ≤700 μm, such as ≤650 μm. The average thickness of the component may be $600 μm, such as ≤550 μm, such as ≤500 μm, such as ≤350 μm, such as $250 μm.

The lattice structure may comprise a higher archival lattice structure.

The component may be a permeate-backing layer component wherein the average thickness of the component is ≤120 μm, such as $100 μm, such as $80 μm, such as ≤50 μm, such as ≤30 μm.

The component may be operable to provide a Reynolds number (Re) of at least 2300 at a flow rate of between 0 and 1 m/s.

The component may be operable to function at a transmembrane pressure of 30 bar to 50 bar, such as 32 bar to 48 bar, such as 34 bar to 46 bar, 36 bar to 44 bar, 38 bar to 42 bar, such as when filtering sea water.

The component may be operable to function at a transmembrane pressure of 3 bar to 15 bar, such as 5 bar to 12 bar, such as 6 bar to 9 bar.

The component may have a packing density of ≥650 m²/m³, such as ≥750 m²/m³, such as ≥900 m²/m³.

The first unit cell and/or second unit cell, when present, may be independently in the form of a diamond, cubic, fluorite, octet, kelvin cell, iso truss, hex prism diamond, truncated cube, truncated octahedron, weaire-phelan, body centered cubic, face centered cubic, or triply periodic minimal surface (TPMS).

The first unit cell and/or second unit cell, when present, may be independently in the form of a TPMS structure such as Gyroid, Schwarz Primitive, Schwarz Diamond, Schwarz Cross Layers of Parallels, Schwarz Hexagonal, Split P, Neovius, or Double Gyroid.

A unit cell may comprise the scalar fields of two or more unit cells mixed to produce a new mixed unit cell.

A unit cell may be shelled to form an internally hollow structure.

The term “lamellar structure” herein means a structure having at least two overlapping layers. The term “membrane” herein means a porous barrier operable to assist with the separation of desired dissolved materials (solutes), colloids or particulates from the feed solutions. It may represent an interface between the feed flow and the permeate flow. The term “two-dimensional material” herein means a material with at least one dimension of less than 100 nm.

The term “higher archival lattice structure” herein means a lattice structure containing structural elements which are built out of another lattice structure which can continue to be built out of subsequent lattice structure to an n^{th} degree.

Turbulence is measured by the Reynolds number (Re):

$$Re = \frac{ρ uL}{μ}$$

Wherein ρ is the density of the fluid, u is the flow speed, L is the characteristic linear dimension, and μ is the dynamic viscosity of the fluid.

Advantageously, it has been found that the apparatus and process of the present invention may deliver a monovalent ion (e.g. lithium) separation and purification at high yield and high recovery rate associated with low energy consumption and low operational expenditure cost in a constant manner.

The apparatus/process may also allow for significant reduction of CO₂ emission, land usage, water usage and/or production cycle compared to current methods of separation and purification.

The term ‘brine’ as used herein may mean an aqueous solution of a salt.

The term ‘nanofiltration’ as used herein may refer to a separation technique that utilises a membrane to separate different components within a fluid mixture. The pore size of the nanofiltration membrane may be from 1 to 100 nm.

For the purpose of the present invention, an aliphatic group is a hydrocarbon moiety that may be straight chain (i.e. unbranched), branched, or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl cycloalkenyl, alkynyl or cycloalkenyl groups, and combinations thereof. The term “(hetero) aliphatic” encompasses both an aliphatic group and/or a heteroaliphatic group.

An aliphatic group is optionally a C₁₋₃₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Optionally, an aliphatic group is a C₁₋₁₅ aliphatic, optionally a C₁₋₁₂ aliphatic, optionally a C₁₋₁₀ aliphatic, optionally a C₁₋₈ aliphatic, such as a C₁₋₆ aliphatic group. Suitable aliphatic groups include linear or branched, alkyl, alkenyl and alkynyl groups, and mixtures thereof such as (cycloalkyl)alkyl groups, (cycloalkenyl)alkyl groups and (cycloalkyl)alkenyl groups.

The term “alkyl,” as used herein, refers to saturated, straight- or branched-chain hydrocarbon radicals derived by removal of a single hydrogen atom from an aliphatic moiety. An alkyl group is optionally a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Optionally, an alkyl group is a C₁₋₁₅ alkyl, optionally a C₁₋₁₂ alkyl, optionally a C₁₋₁₀ alkyl, optionally a C₁₋₈ alkyl, optionally a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight- or branched-chain aliphatic moiety having at least one carbon-carbon double bond. The term “alkynyl,” as used herein, refers to a group derived from the removal of a single hydrogen atom from a straight- or branched-chain aliphatic moiety having at least one carbon-carbon triple bond. Alkenyl and alkynyl groups are optionally “C₂₋₂₀alkenyl” and “C₂₋₂₀alkynyl”, optionally “C₂₋₁₅ alkenyl” and “C₂₋₁₅ alkynyl”, optionally “C₂₋₁₂ alkenyl” and “C₂₋₁₂ alkynyl”, optionally “C₂₋₁₀ alkenyl” and “C₂₋₁₀ alkynyl”, optionally “C₂₋₈ alkenyl” and “C₂₋₈ alkynyl”, optionally “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicyclo[2,2,1]heptane, norborene, phenyl, cyclohexene, naphthalene, spiro[4.5]decane, cycloheptane, adamantane and cyclooctane.

A heteroaliphatic group (including heteroalkyl, heteroalkenyl and heteroalkynyl) is an aliphatic group as described above, which additionally contains one or more heteroatoms. Heteroaliphatic groups therefore optionally contain from 2 to 21 atoms, optionally from 2 to 16 atoms, optionally from 2 to 13 atoms, optionally from 2 to 11 atoms, optionally from 2 to 9 atoms, optionally from 2 to 7 atoms, wherein at least one atom is a carbon atom. Optional heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of the C₃₋₂₀ cycloalkyl group include cyclopropyl, cyclobutyl, cyclopentyl, cyclohexyl, cycloheptyl, adamantyl and cyclooctyl.

An aryl group or aryl ring is a monocyclic or polycyclic ring system having from 5 to 20 carbon atoms, wherein at least one ring in the system is aromatic and wherein each ring in the system contains three to twelve ring members. An aryl group is optionally a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, anthracyl group, naphthyl group or azulenyl group and the like. It should be noted that condensed rings such as indan, benzofuran, phthalimide, phenanthridine and tetrahydro naphthalene are also included in the aryl group.

As used herein, unless otherwise expressly specified, all numbers such as those expressing values, ranges, amounts or percentages may be read as if prefaced by the word “about”, even if the term does not expressly appear. The term “about” when used herein means +/−10% of the stated value.

Singular encompasses plural and vice versa. For example, although reference is made herein to “a” prefiltration portion, “a” microfiltration membrane, and the like, one or more of each of these and any other components can be used.

As used herein, the terms “on”, “applied on/over”, “extend over”, “formed on/over” and “provided on/over” mean formed or provided on but not necessarily in contact with the surface. For example, a coating “formed over” a substrate does not preclude the presence of another coating of the same or different composition located between the formed coating and the substrate.”

The terms “comprising” and “comprises” as used herein are synonymous with “including” or “containing” and are inclusive or open-ended and do not exclude additional, non-recited members, elements or method steps. Additionally, although the present invention has been described in terms of “comprising”, the apparatus detailed herein may also be described as “consisting essentially of” or “consisting of”.

Also, any numerical range recited herein is intended to include all sub-ranges subsumed therein. Singular encompasses plural and vice versa.

As used herein, the term “polymer” refers to oligomers and both homopolymers and copolymers, and the prefix “poly” refers to two or more. Including, for example and like terms means including for example but not limited to.

Additionally, although the present invention has been described in terms of “comprising”, the processes, materials, and compositions detailed herein may also be described as “consisting essentially of” or “consisting of”.

When used herein, “average” refers to mean average, unless otherwise provide for.

Where ranges are provided in relation to a genus, each range may also apply additionally and independently to any one or more of the listed species of that genus.

All of the features contained herein may be combined with any of the above aspects in any combination.

For a better understanding of the invention, and to show how aspects of the same may be carried into effect, reference will now be made, by way of example, to the following experimental data and figures.

### EXAMPLES

FIG. 1 shows a first comparative example using chemical precipitation. However, this method requires high level of chemicals and generates huge amounts of waste.

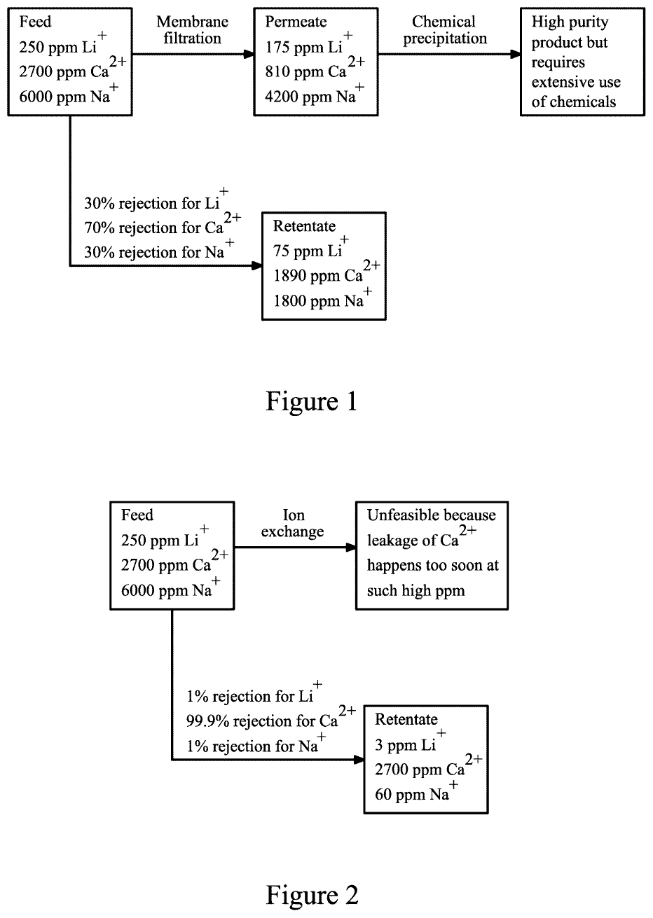

FIG. 2 shows a second comparative example using an ion exchange stage directly. This method is found to lead to a very quick saturation of ion exchange resins by divalent cations (e.g., Ca²⁺) and breakthrough of divalent cations into permeate, resulting in an unviable process.

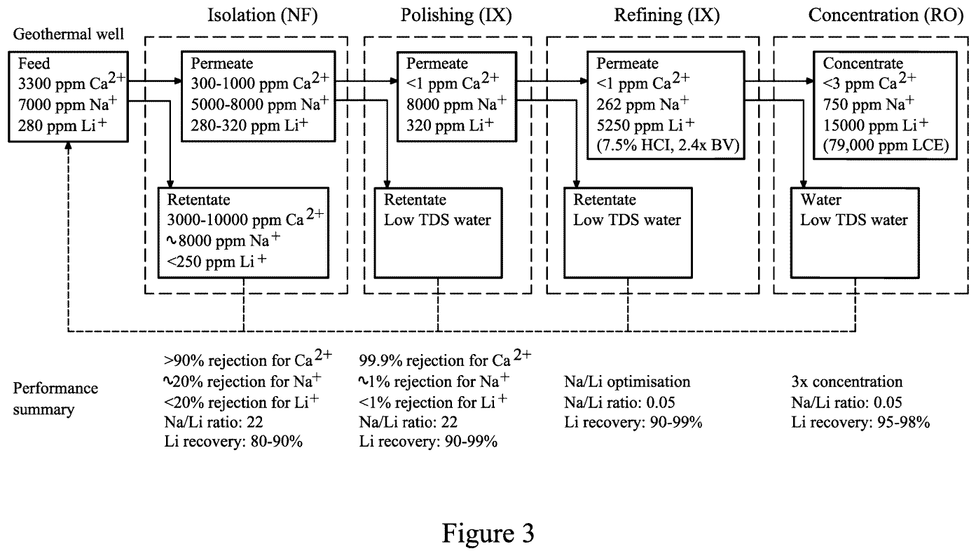

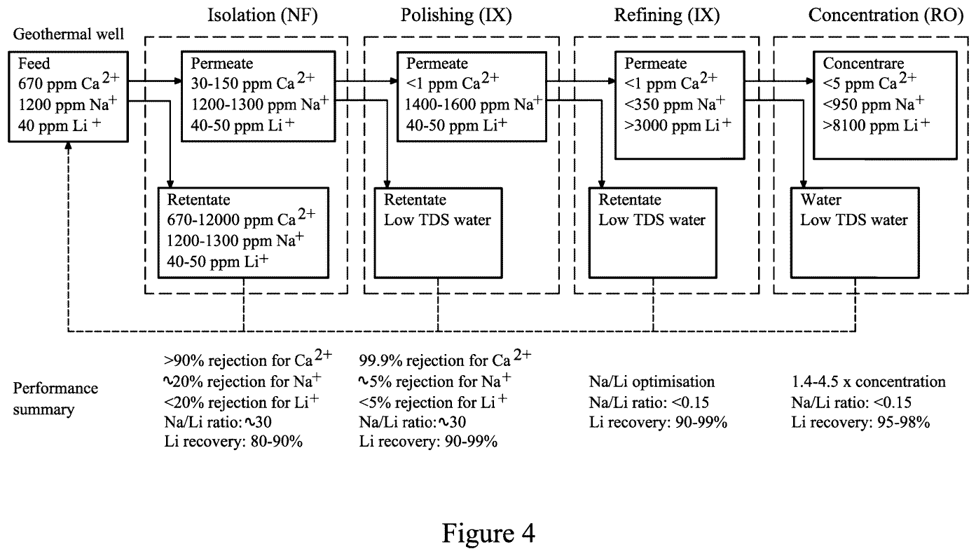

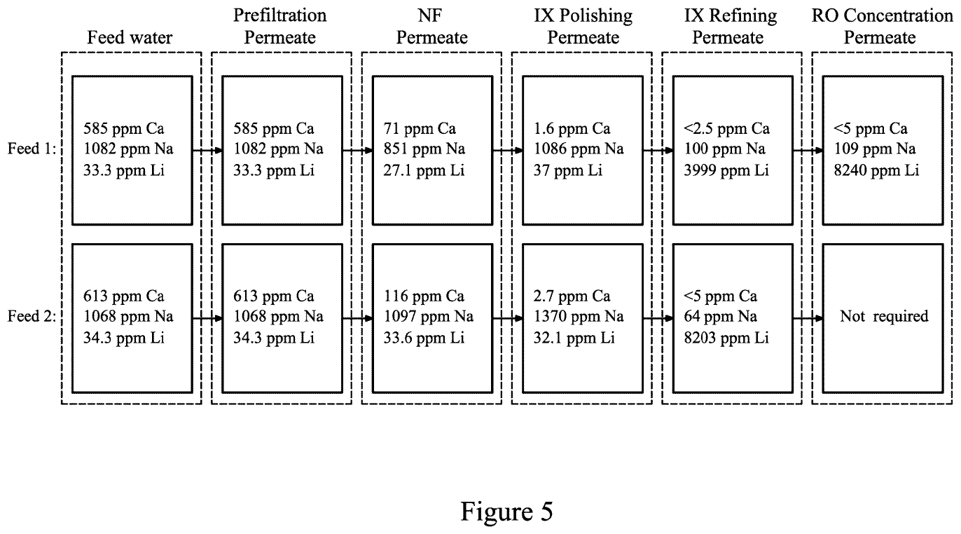

FIGS. 3 to 5 show three different embodiments of a lithium extraction process according to the present invention. The example processes of FIGS. 3 to 5 use exemplary feed sources with different compositions. References to ‘isolation’ permeate or ‘NF permeate’ are to the intermediate solution. References to ‘polishing permeate’ are to the product solution. References to ‘refining permeate’ are to the refined product solution. References to ‘concentration permeate’ are to the concentrated product solution. ‘NF’ means nanofiltration separation portion. ‘IX’ mean ion-exchange separation portion. ‘RO’ means reverse osmosis concentration portion.

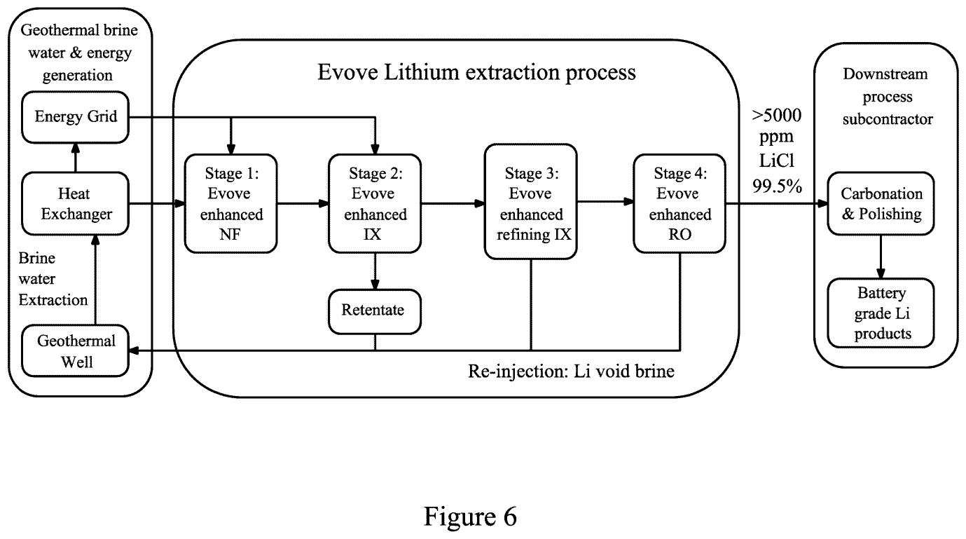

FIG. 6 shows the lithium extraction process of the present invention in a wider context, contained within the initial stages of brine water extraction, heat exchange and possible energy generation that can be fed into the extraction process, and followed by downstream processing including carbonation & polishing, and the possible use in the production of battery grade lithium products.

### NANOFILTRATION

### Example Nanofiltration Membranes 1 to 5

### Coating Formulations

Coating formulation 1: A 2 L coating composition was formed containing 2 g of 3,4-dihydroxyphenethylamine hydrochloride (dopamine) as a hydrophilic agent, 2 g of polyethylenimine (PEI, branched) as a crosslinker for the dopamine, and 2 g of sodium metaperiodate as an oxidative polymerisation initiator in water. A PEI having a molecular weight of 600 Da was used in Example Nanofiltration Membrane 2 and a PEI having molecular weight of 1,800 Da was used in Example Nanofiltration Membrane 3.

Coating formulation 2: A 2 L coating composition was formed containing 2 g of 3,4-dihydroxyphenethylamine hydrochloride (dopamine) as a hydrophilic agent, and 2 g of sodium metaperiodate as an oxidative polymerisation initiator in water.

Coating formulation 3: A 2 L coating composition was formed containing 2 g of polyethylenimine (PEI, branched).

### Production of Example Nanofiltration Membranes 1 to 5

A polyamide thin-film composite flat sheet NF membrane (Alfa Laval NF) was used as the membrane substrate. Example Nanofiltration Membrane 1 was uncoated. For Example Nanofiltration Membranes 2 to 4, the substrate membrane was rinsed with deionised water for 1 hour before the coating composition was coated onto the membrane substrate by dip coating. Example Nanofiltration Membranes 2 and 3 were coated by co-deposition and Example Nanofiltration Membranes 4 and 5 were coated by separate deposition. For co-deposition, the membrane substrate was soaked in coating formulation 1 for 1 hour. For separate deposition, the membrane substrate was soaked in coating formulation 2 for 1 hour, rinsed with deionised water, and then soaked in coating formulation 3 for 1 hour. Coated membranes by both co-deposition and separate deposition methods were rinsed with water before testing.

### Processing of Prefiltered Source Solution Feed Through Nanofiltration Membrane

For each of Example Nanofiltration Membranes 1 to 5, the feed tank of an Alfa Laval M20 cross-flow filtration system comprising the example membrane was filled with 8 L of a prefiltered source aqueous solution feed obtained from a deep geothermal brine in Cornwall.

A transmembrane pressure of 20 bar and a feed flow rate of 7.5 L/min was used to contact the source aqueous solution with the membrane.

During the cross-flow filtration testing, permeate flux was monitored by collecting the permeate in a beaker on a weight balance connected with a data logger. Overall rejection was calculated based on conductivity of permeate and feed tank monitored by conductivity meter. Rejection of specific ions was calculated based on concentration of different ions in permeate and feed tank monitored by inductively coupled plasma optical emission spectrometry (ICP-OES). Separation factor between Li and Ca was calculated by the ratio of concentration of Li and Ca in the permeate divided by the ratio of concentration of Li and Ca in the feed.

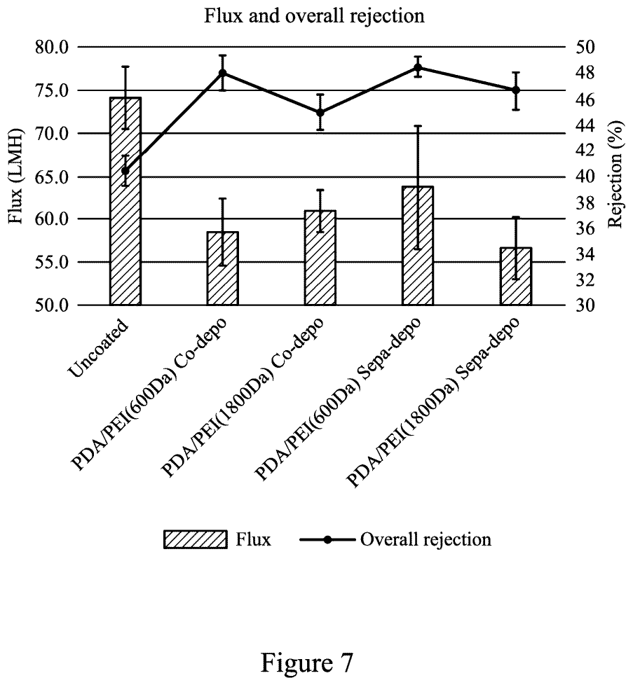

The results showed good flux and excellent overall rejection (FIG. 7).

The results also show that compared with the uncoated membrane 1, the coated membranes 2 to 5 continue to maintain a good flux while in combination with further increased overall rejection (FIG. 7).

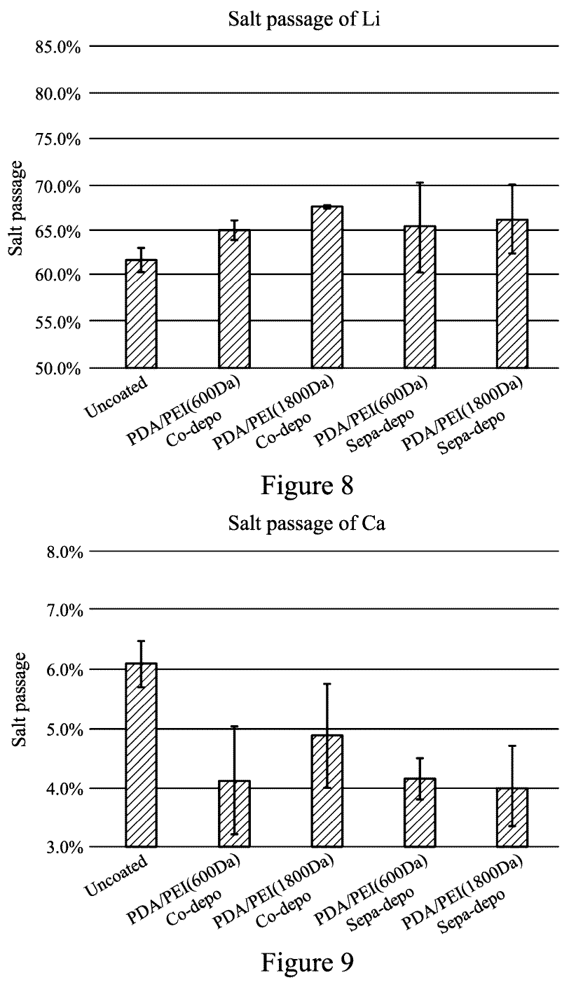

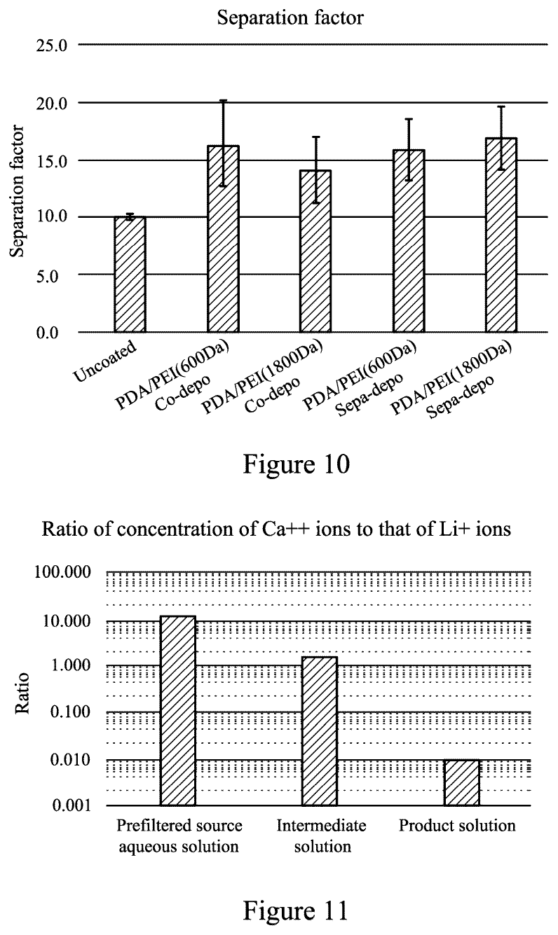

Compared with the uncoated membrane, the coated membranes have an increased salt passage of Li (FIG. 8) and a decreased salt passage of Ca (FIG. 9), leading to increased separation factor between Li and Ca (FIG. 10).

### Production of Product Solution

### Example Nanofiltration Membrane 6

### Coating Formulation

A three-part, aqueous coating formulation was prepared by dissolving A) 10 g of dopamine hydrochloride in 4 L of deionized water, B) 10 g of polyethyleneimine (600 Da Mw) in 3 L of deionized water and C) 10 g of sodium periodate in 3 L of deionized water.

### Production of Example Nanofiltration Membrane 6

A spiral-wound polyamide thin-film composite nano-filtration membrane was used as the substrate. The membrane was installed into a suitable housing and attached to a Alfa Laval M20 cross-flow filtration system.

Prior to coating, the three components of the coating formulation A, B and C were combined in a container to begin an oxidative polymerization/cross-linking reaction. The resulting solution was added to the feed tank of the Alfa Laval M20 cross-flow filtration system and was circulated through the membrane for a period of 1 hour at a flow rate of 5 L/min. No additional pressure was applied to the system during this time.

After the coating period had finished, the membrane was flushed with a sufficient volume of deionized water until the effluent was deemed to be colourless. The coated membrane was uninstalled from the housing and allowed to drain of excess water for a period of 1 hour.

### Processing of Source Aqueous Solution Feed

A feed tank of Alfa Laval M20 cross-flow filtration system was filled with 40 L of prefiltered source aqueous solution feed obtained from a deep geothermal brine in Cornwall.

The coated spiral-wound membrane of Example Nanofiltration Membrane 6 was installed in the appropriate housing on the Alfa Laval M20 cross-flow filtration system.

The prefiltered source solution was passed through the membrane at a flow rate of 20 L/min and a pressure of 20 Bar. The filtration was run in a concentrate mode. Permeate streams were collected in a separate permeate tank and the membrane retentate was recirculated back to the feed tank until such a time that the feed volume was not sufficient to run the system.

During the cross-flow filtration testing, permeate flux was monitored by collecting the permeate in a beaker on a weight balance connected with a data logger. Rejection was calculated based on concentration of different ions in permeate and feed tank monitored by inductively coupled plasma optical emission spectrometry (ICP-OES) and ion chromatography (IC).

Example Nanofiltration Membrane 6 produced an intermediate aqueous solution having excellent rejection towards Ca (88%, with Ca concentration drops from 3325.3 ppm to 397.3 ppm) with low levels of rejection towards Li (11%, with Li concentration drops from 289.3 ppm to 257.7 ppm). This resulted in a significantly reduced ratio of concentration between Ca and Li (from 11.49 to 1.54) in the intermediate aqueous solution (Table 1 and FIG. 11).

### Processing of Intermediate Aqueous Solution Through Ion-Exchange Resin

The permeate collected from the nanofiltration stage using Example Nanofiltration Membrane 6 was used as the intermediate aqueous solution feed for the ion-exchange stage.

Lanxess Lewatit TP 208 was used as the ion-exchange resin.

A peristaltic pump was used to transfer the intermediate aqueous solution feeds from the feed tanks into the columns and the flowrates were controlled by the pump to obtain a velocity of 8 m/hr through the cross-section of the column.

Effluent was collected at an interval of 1 BV (bed volume, the volume of space in chromatography column occupied by resins) and the compositions were monitored by ICP-OES. A breakthrough curve of divalent cations concentration vs. BV was drawn and breakthrough point of divalent cations (where divalent cations can be detected in the permeate) was be determined.

A working cycle was deemed finished once the breakthrough point of divalent cations was reached and the resins were regenerated using 7.5% HCl and 4% NaOH solution before the second working cycle started.

Once a suitable amount of permeate was collected, ICP-OES was used for ion concentration determinations and rejection calculations. In the product aqueous solution obtained from the effluent at least 99% of the divalent ions were removed with the effluent mainly consisting of monovalent ions.

The results show that Ca concentration in the ion exchange effluent is reduced to <3 ppm while Li concentration is maintained at substantially the same level (270 ppm) compared with the ion exchange influent. The ratio of concentration between Ca and Li in the product aqueous solution was further reduced to 0.01 (Table 1 and FIG. 11).

TABLE 1
Results

| | | | Ratio of |
|---|---|---|---|
| | Concentration | | concentration of |
| | (ppm) | | Ca++ ions to Li+ |
| Stage | Ca++ | Li+ | ions |
| Prefiltered source aqueous solution | 3325.3 | 289.3 | 11.49:1 |
| Intermediate solution | 397.3 | 257.7 | 1.54:1 |
| Product solution | 2.82 | 270 | 0.01:1 |

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An apparatus for reducing the ratio of divalent ions to a target monovalent ion in an aqueous solution from a source aqueous solution that contains a higher ratio of divalent ions to the target monovalent ion, the apparatus comprising:
optionally, a prefiltration portion operable to receive the source aqueous solution and produce a prefiltered source aqueous solution;
a first separation portion operable to receive the optionally prefiltered source aqueous solution and form an intermediate aqueous solution having a lower ratio of divalent ions to the target monovalent ion than the optionally prefiltered source aqueous solution; and
a second separation portion operable to receive the intermediate aqueous solution and form a product aqueous solution having a lower ratio of the divalent ions to the target monovalent ion than the intermediate solution.

2. (canceled)

3. (canceled)

4. (canceled)

5. (canceled)

6. (canceled)

7. (canceled)

8. The apparatus according to claim 1, wherein the first separation portion comprises a nanofiltration separation portion, and wherein the nanofiltration separation portion comprises a nanofiltration membrane.

9. (canceled)

10. (canceled)

11. (canceled)

12. (canceled)

13. The apparatus according to claim 1, wherein the prefiltration portion and/or first separation portion comprises a membrane comprising polyamide; polyester; and/or, poly(ether) sulfone (PES).

14. (canceled)

15. (canceled)

16. The apparatus according to claim 1, wherein the first separation portion comprises a membrane that comprises a spiral wound membrane.

17. (canceled)

18. (canceled)

19. (canceled)

20. (canceled)

21. (canceled)

22. (canceled)

23. (canceled)

24. (canceled)

25. The apparatus according to claim 1, wherein the second separation portion comprises an ion-exchange resin, and wherein the ion-exchange separation portion comprises an ion exchange resin.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. The apparatus according to claim 1, wherein the prefiltration, first and/or second separation portions comprises a membrane that comprises a membrane substrate and a coating extending over at least a part of the membrane substrate.

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. The apparatus according to claim 1, wherein the prefiltration portion and/or a separation portion comprises a membrane comprising a porous ceramic member, wherein the porous ceramic member comprises a first support portion operable to support a coating and further comprises a second support portion, wherein the second support portion has a higher D75 average pore size than the D75 average pore size of the first support portion, wherein the second support portion comprises a lattice structure that has a porosity percentage of ≥40%, and wherein the porous ceramic member has a tensile strength operable to withstand feed application pressure of ≥100 kPa (1 bar).

64. The apparatus according to claim 1, wherein the prefiltration portion and/or a separation portion comprises a spiral wound membrane having a component comprising an integrally formed non-uniform lattice structure, wherein the lattice structure comprises a first and second repeating unit cell, wherein the first and second unit cells are different.

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. A process for reducing the ratio of divalent ions, to a target monovalent ion in an aqueous solution, comprising:
a. optionally, contacting a source aqueous solution comprising the divalent ions and the target monovalent ion with a prefiltration portion according to claim 1;
b. contacting the optionally prefiltered aqueous solution with a first separation portion according to claim 1 to form an intermediate aqueous solution having a lower ratio of the divalent ions to the target monovalent ion than the optionally prefiltered aqueous solution;
c. contacting the intermediate solution with a second separation portion according to claim 1 to form a product aqueous solution having a lower ratio of the divalent ions to the target monovalent ion than in the intermediate solution.

80. (canceled)

81. (canceled)

82. (canceled)

83. (canceled)

84. (canceled)

85. (canceled)

86. (canceled)

87. (canceled)

88. The process according to claim 79, wherein the target monovalent cation comprises Li, W, Au, Ag, Na and/or K.

89. (canceled)

90. The process according to claim 79, wherein the target monovalent cation comprises Li.

91. (canceled)

92. (canceled)

93. (canceled)

94. (canceled)

95. (canceled)

96. (canceled)

97. A process according to claim 79, wherein the source solution comprises a ratio of the divalent ions to the target monovalent ion of ≥0.05:1.

98. (canceled)

99. (canceled)

100. (canceled)

101. (canceled)

102. (canceled)

103. The process according to claim 79, wherein the prefiltered solution comprises a ratio of the divalent ions to the target monovalent ion of ≥0.05:1.

104. (canceled)

105. (canceled)

106. (canceled)

107. (canceled)

108. (canceled)

109. (canceled)

110. (canceled)

111. (canceled)

112. (canceled)

113. The process according to claim 79, wherein the intermediate solution comprises a ratio of the divalent ions to the target monovalent ion of ≤10:1.

114. (canceled)

115. (canceled)

116. (canceled)

117. (canceled)

118. (canceled)

119. (canceled)

120. (canceled)

121. (canceled)

122. The process according to claim 79, wherein the product solution comprises a ratio of the divalent ions to the target monovalent ion to of ≤0.025:1.

123. (canceled)

124. (canceled)

125. (canceled)

126. (canceled)

127. The process according to claim 79, wherein the process further comprises:
d. contacting the product solution with a (further) ion exchange separation portion to form a refined product aqueous solution having a lower ratio of a different type of monovalent ion to the target monovalent ion than in the product solution.

128. (canceled)

129. (canceled)

130. (canceled)

131. (canceled)

132. (canceled)

133. (canceled)

134. (canceled)

135. (canceled)

136. The process according to claim 127, wherein the different type of monovalent ion to the target monovalent ion comprises a different type of monovalent cation.

137. (canceled)

138. (canceled)

139. (canceled)

140. (canceled)

141. (canceled)

142. (canceled)

143. (canceled)

144. (canceled)

145. (canceled)

146. (canceled)

147. (canceled)

148. (canceled)

149. (canceled)

150. (canceled)

151. (canceled)

152. (canceled)

153. (canceled)

154. An apparatus according to claim 1, for use in lithium extraction.

155. A product aqueous solution obtained by a process according to claim 79.

156. A dry product composition obtained by a process according to claim 79.
